(19) United States
(12) Patent Application Publication
(10) Pub. No.: US 2026/0367668 A1
(43) Pub. Date: Nov. 19, 2026

(54) MÓTUS™ MODULAR WEARABLE SYSTEM WITH STANDARDIZED CARRIER INTERFACE.

(71) Applicant: Chima Darlington Imoh, Charleston, WV (US)

(72) Inventor: Chima Darlington Imoh, Charleston, WV (US)

(21) Appl. No.: 19/754,369

(22) Filed: Jul. 27, 2026

Related U.S. Application Data
(63) Continuation-in-part of application No. 19/194,033, filed on Apr. 30, 2025.
(60) Provisional application No. 63/869,287, filed on Aug. 23, 2025.
(60) Provisional application No. 63/869,429, filed on Aug. 24, 2025.

(51) Int. Cl. G06F 1/16; A45F 5/00

(52) U.S. Cl. CPC G06F 1/163; A45F 5/1525

(57) ABSTRACT

A modular wearable system includes a detachable electronics module, referred to as a Mótus™ pod, removably received within any of a plurality of carriers, including footwear, wristband, wristwatch, ankle, clip-on, standalone, glove, tongue, and medical wearable carriers, each having a module cavity with a standardized mechanical alignment and electrical contact pattern. A wearable operating system, Reflexion OS, automatically detects the carrier type, dynamically assigns device roles among one or more pods, and synchronizes motion telemetry across the pods. The Mótus™ pod may be implemented with or without a local display, and may be charged through a docking station, a compatible carrier cavity, or a detachable battery-integrated tongue carrier.

### CROSS-REFERENCE TO RELATED APPLICATIONS

This application is a continuation-in-part of U.S. patent application Ser. No. 19/194,033, entitled “Mótus™ Smart Footwear,” filed Apr. 30, 2025, the entire disclosure of which is incorporated herein by reference. This application further claims the benefit under 35 U.S.C. § 119(e) of U.S. Provisional Patent Application No. 63/869,287, entitled “Detachable Modular Footwear System with Embedded Smart Display and Electronics,” filed Aug. 23, 2025, and U.S. Provisional Patent Application No. 63/869,429, entitled “Detachable Screen Tongue Module and Multi-Mode Footwear Integration,” filed Aug. 24, 2025, the entire disclosures of each of which are incorporated herein by reference.

### FIELD OF THE INVENTION

The present invention relates generally to wearable technology, and more specifically to a modular wearable system comprising a detachable electronics module, referred to herein as a Mótus™ pod, that is removably received within any one of a plurality of compatible carriers and that exchanges power and data with at least some of said carriers by way of a standardized cavity and socket interface. The compatible carriers include, without limitation, articles of footwear, detachable tongue assemblies, wristbands and wristwatch carriers, ankle bands, clip-on carriers, glove or hand-worn carriers, standalone carriers, and rehabilitative or medical wearable carriers. The present invention further relates to a wearable operating system, referred to herein as Reflexion OS, configured to detect the type of carrier presently coupled to a Mótus™ pod, to assign device roles among one or more Mótus™ pods worn by a user, and to synchronize motion telemetry across the plurality of compatible carriers. In one or more embodiments, the Mótus™ pod is offered as a hardware product line of MiMiroir Technologies, the wearable operating system referred to herein as Reflexion is offered as the corresponding software platform of MiMiroir Technologies, and the Mótus™ pod, the standardized cavity and socket interface, the plurality of compatible carriers, and the Reflexion software platform together form a unified modular wearable ecosystem.

### BACKGROUND OF THE INVENTION

Footwear has historically been designed primarily to provide protection, comfort, and stylistic expression to the wearer. More recent developments in the field of athletic and lifestyle footwear have introduced limited electronic functionality, including basic step-counting modules, embedded fitness sensors, and proprietary mobile applications that pair with such sensors over wireless protocols. These products, while useful for tracking gross activity metrics, suffer from several limitations that have prevented footwear from being adopted as a fully integrated wearable computing platform.

First, existing smart footwear products are typically designed as standalone devices and do not interoperate with a broader, cohesive wearable operating system. As a result, data collected by such footwear cannot be readily synchronized with companion devices, such as smart eyewear, smartwatches, or augmented and virtual reality headsets, in a unified manner. Second, existing footwear products generally do not provide a standardized cavity-and-pod architecture in which the same removable electronics module may operate across footwear, wrist, clip, glove, tongue, and other carrier forms. Third, existing products generally fail to support both display-equipped and non-display pod embodiments within the same carrier ecosystem.

Further, existing wearable products typically require each form factor to carry its own dedicated electronics. This duplicates cost, complicates upgrades, fragments user data, and prevents a user from moving a trusted electronics module between different physical carriers.

Compounding the foregoing limitations, existing smart footwear products typically embed their electronic components permanently within the footwear structure. Permanent embedding renders the electronic components difficult or impossible to repair, upgrade, or replace; complicates routine cleaning of the footwear; precludes the wearer from removing the electronic components for separate use as a wearable accessory; and prevents the wearer from interchanging modules to suit different activities, fashion preferences, or hardware tiers. Existing smart footwear products further fail to provide a modular cavity-and-module architecture in which a single electronic module may be transferred between footwear bodies, between left and right articles of a pair, or between footwear and an alternative carrier such as a wrist strap or clip accessory.

By way of representative example, a known approach to automating shoe closure is described in Feinstein, U.S. Patent Application Publication No. 2018/0084868 A1, which discloses self-fitting and automatically adjustable footwear in which a shape-memory material such as nitinol, in cooperation with motor-actuated tensioning, magnetic clasps, sensors, and a control unit, opens and closes the shoe upper around the wearer's foot. Although Feinstein contemplates wireless data exchange between the footwear control unit and various companion devices, including smart watches, fitness trackers, and electronic medical records, and contemplates a charging dock station for replenishing an internal battery, Feinstein does not disclose an integrated electronic display panel positioned in the tongue region of the footwear and configured to render dynamic graphical content visible to the wearer. To the extent Feinstein refers to a touch screen at all, that reference is to a user input unit by which the wearer issues commands to the control unit, and is not a description of an output display configured to present fitness metrics, navigation prompts, time information, or notifications received from a wearable operating system. Feinstein further fails to disclose a power light indicator strip extending along an exterior surface of the footwear and comprising a plurality of addressable light-emitting elements arranged to communicate visual status information through programmatic variation in color, brightness, illumination pattern, and animation. References in Feinstein to radio-frequency identification signals, infrared, laser beams, or light or optical sensors are descriptions of stimuli used to actuate shape-memory material or sensors used to detect such stimuli, not descriptions of an exterior visual status indicator. Feinstein further fails to disclose dynamic cosmetic customization of the footwear's appearance under the wearer's control, nor does Feinstein disclose the operation of the footwear as a component of a unified wearable operating system that synchronizes data, content, and visual appearance with companion wearable devices.

A further representative example of relevant prior art is described in Lee et al., U.S. Pat. No. 10,536,023 B2, which discloses an intelligent insole module having an acceleration sensor, a gyroscope, a wireless transmitter, a battery, and a magnetic charging structure positioned at a charging interface of the insole module. Although Lee discloses a discrete insole module that may be inserted between insole layers and removed for charging, Lee does not disclose a standardized tongue-region or multi-carrier cavity sized and shaped to receive a removable Mótus™ pod that can operate across footwear, wrist, clip, glove, tongue, and other carrier forms under a unified Reflexion OS environment.

The foregoing examples are representative of the state of the art. They address discrete aspects of footwear or wearable electronics, but do not disclose or suggest the combination of a removable electronics pod, a standardized carrier cavity, optional display and non-display pod embodiments, carrier-side charging/support structures, and a wearable operating system configured to coordinate pod identity, carrier identity, motion telemetry, and device roles across multiple carrier types.

There further exists a significant unmet need in the art for a unified modular wearable platform that supports interoperable operation of a single electronics module across multiple wearable form factors. Existing wearable products are typically purpose-built for a single form factor, such that a smart watch, a smart shoe, and a clip-on activity tracker each include their own dedicated electronics, batteries, displays, and wireless radios, and cannot share components, share user profile data, or coordinate sensing across the multiple devices worn simultaneously by the same user. As a consequence, the user is required to maintain, charge, configure, and update a plurality of independent devices; user data is fragmented across device-specific applications; and the per-device cost of computing, sensing, and connectivity is duplicated across the user's wearable inventory.

In a separate line of art, several wearable products have attempted to address user fragmentation by providing a single electronics module that attaches to multiple accessories. By way of representative example, the Misfit Shine activity tracker, commercially introduced in 2013, comprises a metal disc housing a battery, motion sensors, and a low-power processor, the disc being releasably retained within any one of a wristband, a magnetic clothing clip, an ankle band, a necklace, or a shoe-lace clip accessory; the Misfit Shine is recharged through a dedicated wireless cradle, communicates information to the wearer only through a ring of light-emitting diodes rather than through any embedded electronic display, and provides no electrical contact interface between the disc and any of its accessories. As a further representative example, Vincze, U.S. Patent Application Publication No. 2016/0029778 A1, discloses a wearable modular electronic device configured to attach to wearable accessories including jewelry, money clips, belt buckles, handbags, articles of clothing, and a wristwatch clasp assembly; Vincze does not, however, disclose a footwear accessory, a standardized cavity and socket interface providing both electrical power and data communication between the device and the accessory, or any operating system configured to automatically detect the type of accessory to which the device is presently coupled. As yet further representative examples, U.S. Pat. No. 7,618,260 discloses a wearable modular interface strap having electrically connected nodes that act as docking points for removable and interchangeable modules within the strap, the disclosed strap being limited to a single carrier form factor; and U.S. Pat. No. 8,787,006 discloses a wrist-worn electronic device assembly in which a detachable mobile electronic device, separately useable as a standalone electronic device, may be coupled into a receptacle of an electronic wristband to function as a wristwatch, the disclosed assembly being limited to wrist and standalone form factors and providing no automatic carrier detection or dynamic reconfiguration of operation in response to a detected carrier type. None of the foregoing references discloses or suggests a standardized cavity and socket interface common across heterogeneous wearable carrier types of differing form factor, the interface providing both electrical power and data communication between a detachable electronics module and any such carrier, in combination with a wearable operating system configured to automatically detect, upon coupling of the module to any said carrier, the type of carrier presently coupled to the module and to dynamically reconfigure operation of the module in accordance with the detected carrier type. None of the foregoing references further discloses or suggests the coordination of a plurality of such modules worn by the same user, including the bilateral classification of motion events, such as disambiguating a paired-foot stomp from a single-foot hop.

There accordingly exists a significant unmet need in the art for a unified modular wearable platform that combines: a detachable electronics module housing core processing, sensing, wireless communication, memory, and power components; a plurality of compatible carriers of differing form factor, each carrier including a standardized cavity having alignment, retention, and optional electrical contacts; and a wearable operating system configured to detect carrier context, assign device roles, and synchronize motion telemetry across one or more pods.

There exists, therefore, a significant unmet need in the art for a modular wearable system that provides a removable electronics pod, a standardized cavity-and-carrier architecture, optional display and non-display pod embodiments, and software coordination across footwear, wrist, clip, glove, tongue, and other compatible carriers. The present invention addresses these and other needs.

### SUMMARY OF THE INVENTION

The present invention provides a modular wearable system that operates as a unified hardware and software platform for wearable electronics. The system comprises a detachable electronics module, referred to herein as a Mótus™ pod, sized and shaped to be removably received within any one of a plurality of compatible carriers, and a wearable operating system, referred to herein as Reflexion OS, that coordinates operation across one or more Mótus™ pods worn by a user. The plurality of compatible carriers includes, without limitation, footwear carriers, wristband and wristwatch carriers, ankle band carriers, clip-on carriers, standalone carriers, and rehabilitative or medical wearable carriers, each said carrier comprising a respective cavity sized and shaped to removably receive the Mótus™ pod and including alignment, retention, and electrical contact features that conform to a standardized interface common across the plurality of carriers.

In one aspect, the invention provides a Mótus™ pod that houses, within a sealed enclosure, any combination of a display, a processor, a memory module, a wireless communication module, an inertial measurement unit, one or more environmental sensors, a rechargeable energy storage device, and an inductive charging coil, such that the Mótus™ pod constitutes a complete wearable computer that may be operated independently of any carrier while retaining the option of installation within any compatible cavity for power, sensing, display, or actuator extension.

In a further aspect, the invention provides a modular cavity and socket architecture that may be embodied as a flush-fit recessed cavity integrated into a footwear structure, detachable tongue assembly, wristband, wristwatch case or strap, ankle band, clip-on body, standalone cradle, glove carrier, brace, sleeve, orthosis, or other wearable or portable carrier. The cavity is configured with a retention system selected from one or more of rails, latches, magnets, clips, gaskets, friction fit, and hybrid mechanisms; may be configured as a sealed cavity providing water and sweat resistance to electronic components retained therein; and may be configured to receive a decorative or passive cavity insert when no active Mótus™ pod is installed therein.

In still further aspects, the invention provides electrical interface and charging embodiments by way of which a Mótus™ pod is electrically coupled to a carrier, the electrical interface and charging embodiments comprising one or more of spring-loaded pogo-pin contacts, flat contact-pad interfaces, wireless inductive charging in accordance with the Qi standard or any other compatible wireless-power standard, and dock-assisted charging in which the Mótus™ pod, the carrier, or both is received within a docking station that provides one or more of mechanical alignment, electrical charging, data communication, and firmware update. The smart system is further configured to perform hot-swap detection upon insertion or removal of the Mótus™ pod and to perform module authentication through the electrical interface by way of one or more of a digital identification pin, a secure element challenge-response exchange, and a near-field communication or radio-frequency identification identifier.

In a yet further aspect, the invention provides a Reflexion OS environment configured to detect the type of carrier to which each Mótus™ pod is presently coupled; to detect a left-side or right-side orientation of each pod; to dynamically assign device roles among a plurality of pods worn by the user, the device roles including, without limitation, primary display, secondary display, primary sensor source, secondary sensor source, haptic source, audio source, gesture controller, game-input controller, training source, and care or movement workflow source; to synchronize motion telemetry across the plurality of pods; and to process synchronized motion telemetry into coordinated software, haptic, audio, visual, or cloud-based outputs of the ecosystem.

The modular wearable system may be implemented within, and its operation is not limited to, any particular one of the compatible carriers. Two representative implementations, presented by way of example and not by way of limitation, are described below: a smart footwear system and a wrist-mounted system. In each such implementation, the Mótus™ pod and Reflexion OS provide the core computing, sensing, display, and wireless functions described above, and the invention is not limited to the smart footwear implementation or to any other single carrier type.

In one such implementation, the modular wearable system is embodied as a smart footwear system in which a Mótus™ pod is received within a module cavity formed within a smart footwear body or tongue-region carrier. The smart footwear body may further include one or more carrier-side support features, including alignment features, retention features, electrical contacts, a power light indicator strip, one or more passive or active charging interfaces, and, in some embodiments, a detachable tongue assembly configured to receive, retain, charge, or communicate with the Mótus™ pod. The smart footwear implementation may further be provided as a left/right pair in which respective Mótus™ pods cooperate through Reflexion OS to coordinate motion sensing and role assignment.

In another such implementation, the modular wearable system is embodied as a wrist-mounted system in which a Mótus™ pod is received within a wristband carrier or a wristwatch carrier worn upon the wrist of the user. The wrist-mounted system is configured to operate as a primary wearable computer for the user when foot-mounted operation is not available, and is further configured to communicate wirelessly with one or more additional Mótus™ pods worn by the user, including, without limitation, any Mótus™ pod installed within a smart footwear body of the user, such that the wrist-mounted Mótus™ pod and a foot-mounted Mótus™ pod cooperate to present a unified wearable operating environment with sensor and display resources distributed between the wrist and the foot.

By way of non-limiting example, a present prototype of the Mótus™ pod has been implemented using Waveshare AMOLED 1.8 development-kit hardware, presents an approximately two-hour runtime in the prototype configuration, and pairs over Bluetooth Low Energy through a Reflexion companion application that guides the user through pod placement and role assignment, including selection of single-pod or dual-pod operation. The foregoing prototype facts are illustrative implementation context for enablement and are not intended to limit the scope of any commercial embodiment, of the appended claims, or of any equivalent thereof, and the final commercial pod, runtime, connection protocol, and pairing flow may differ in form, function, and parameter values without departing from the scope of the invention.

Numerous other features, aspects, and advantages of the present invention will become apparent from the following detailed description when taken in conjunction with the accompanying drawings and claims.

### BRIEF DESCRIPTION OF THE DRAWINGS

The accompanying drawings, which are incorporated in and constitute a part of this specification, illustrate one or more presently preferred embodiments of the invention and, together with the detailed description, serve to explain the principles of the invention. The drawings are not necessarily drawn to scale.

The drawings primarily illustrate the smart footwear implementation of the modular wearable system as one preferred embodiment of the invention, and additionally include views of selected alternative carrier embodiments, including, without limitation, wristband or wristwatch carriers, ankle-adjacent carriers, clip-on carriers, glove or hand-worn carriers, a schematic block diagram of the internal electronics of the detachable Mótus™ pod, and a non-display pod embodiment series illustrating that the detachable Mótus™ pod may be implemented with or without a local electronic display. Corresponding wrist-mounted, ankle-mounted, clip-on, standalone, hand-worn, tongue-mounted, and rehabilitative implementations of the modular wearable system are described in the textual description that follows.

FIG. 1 is a side elevation view of a smart footwear article according to one embodiment of the present invention.

FIG. 2 is a top plan view of the smart footwear article of FIG. 1.

FIG. 3 is an angled perspective view of the smart footwear article of FIG. 1.

FIG. 4 is a bottom plan view of an insole assembly of the smart footwear article according to one or more embodiments of the present invention.

FIG. 5 is an exploded perspective view of the smart footwear article according to one or more embodiments of the present invention.

FIG. 6 is view of the smart footwear article, and elements thereof, according to one or more embodiments of the present invention.

FIG. 7 is a side view of a footwear carrier and a detachable Mótus™ pod according to one or more embodiments of the present invention.

FIG. 8 is an enlarged view of a standardized pod cavity and socket interface according to one or more embodiments of the present invention.

FIG. 9 is a top view of a footwear carrier and a removable Mótus™ pod according to one or more embodiments of the present invention.

FIG. 10 is a view of a passive or decorative cavity insert according to one or more embodiments of the present invention.

FIG. 11 is a view of a wristband or wristwatch carrier according to one or more embodiments of the present invention.

FIG. 12 is a view of a rehabilitation brace carrier according to one or more embodiments of the present invention.

FIG. 13 is a view of a clip carrier or accessory body according to one or more embodiments of the present invention.

FIG. 14 is a view of left and right footwear carriers configured for paired-pod operation according to one or more embodiments of the present invention.

FIG. 15 is a view of a charging dock configured to receive one or more Mótus™ pods according to one or more embodiments of the present invention.

FIG. 16 is an ecosystem view showing a Mótus™ pod operating across a plurality of compatible carriers according to one or more embodiments of the present invention.

FIG. 17 is a view of a glove or hand-worn carrier according to one or more embodiments of the present invention.

FIG. 18 is a flow diagram illustrating the operative data and command paths within the modular wearable system, depicted in a smart footwear implementation as one representative example, according to one or more embodiments of the present invention.

FIG. 19 is a system-level diagram illustrating the modular wearable system, depicted in a smart footwear implementation as one representative example, communicating with one or more companion devices and cloud-hosted services, according to one or more embodiments of the present invention.

FIG. 20 is a schematic block diagram of the internal electronics of the detachable Mótus™ pod according to one or more embodiments of the present invention.

FIG. 21 is a perspective view of a non-display embodiment of the detachable Mótus™ pod.

FIG. 22 is a view of a footwear carrier receiving a non-display Mótus™ pod, according to one or more embodiments of the present invention.

FIG. 23 is a multi-carrier ecosystem view showing a non-display Mótus™ pod in operation across a plurality of carriers, according to one or more embodiments of the present invention.

FIG. 24 is a system-level diagram illustrating a single non-display Mótus™ pod in bidirectional wireless communication with a companion device executing Reflexion OS and with a cloud-hosted service over a wireless synchronization path, according to one or more embodiments of the present invention.

FIG. 25 is a system-level diagram illustrating a pair of non-display Mótus™ pods in bidirectional wireless communication with a companion device executing Reflexion OS and with a cloud-hosted service over a wireless synchronization path, according to one or more embodiments of the present invention.

FIG. 26 is a view of a detachable tongue assembly configured as a carrier for the detachable Mótus™ pod.

FIG. 27 is an enlarged detail view of a standardized electrical contact pattern of the pod cavity and socket interface, according to one or more embodiments of the present invention.

### DETAILED DESCRIPTION OF THE INVENTION

Reference will now be made in detail to presently preferred embodiments of the invention, examples of which are illustrated in the accompanying drawings. While the invention will be described in connection with these embodiments, it will be understood that the present description is not intended to limit the invention to those embodiments. On the contrary, the invention is intended to cover alternatives, modifications, and equivalents that may be included within the spirit and scope of the invention as defined by the appended claims.

The terminology used herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

### Overview of the Modular Wearable System

The present invention provides a modular wearable system in which a single detachable electronics module, referred to herein as a Mótus™ pod, is configured for operation, without modification, across any one of a plurality of compatible carriers. The Mótus™ pod is sized and shaped to be removably received within a module cavity 132, alternatively referred to herein as a socket, formed within each said carrier. Each said carrier comprises a complementary module cavity 132 that conforms to a standardized mechanical alignment geometry and a standardized electrical contact pattern common across the plurality of carriers, such that the Mótus™ pod is mechanically retained and electrically interfaced consistently regardless of the particular carrier in which it is presently installed. Stated otherwise, the respective module cavity 132 of each said carrier of the modular wearable system shares a standardized mechanical alignment and electrical contact pattern such that the detachable Mótus™ pod 130 is operable, without modification, in the respective module cavity 132 of any compatible carrier of the modular wearable system.

The modular wearable system is configured to support concurrent operation of a plurality of Mótus™ pods worn by the same user. Each Mótus™ pod communicates wirelessly with one or more other Mótus™ pods worn by the user, with one or more companion devices 200, and with one or more cloud-hosted services 202, under coordination of a wearable operating system referred to herein as Reflexion OS. Reflexion OS is configured to detect the type of carrier presently coupled to each Mótus™ pod, in some carriers to detect a left-side or right-side orientation of a pod, to dynamically assign device roles among the pods, to synchronize motion telemetry across the pods, and to process the synchronized motion telemetry into coordinated outputs spanning the displays, light indicators, haptic actuators, and audio outputs of the ecosystem.

### The Mótus™ Pod

The Mótus™ pod, also referred to interchangeably herein as the detachable electronics module 130, comprises a sealed enclosure sized and shaped to be removably received within a corresponding module cavity 132 of any compatible carrier. The Mótus™ pod may comprise a rigid or semi-rigid housing constructed of plastics, composites, machined metal, or combinations thereof, and may take any of a variety of geometries including, without limitation, rectangular, rectangular with rounded corners, oval, circular, curved, or non-uniform geometries that conform to the cavity profile. In a presently preferred embodiment, the Mótus™ pod is sealed against ingress of moisture and particulates to an ingress-protection rating suitable for sustained wear in athletic and everyday environments, and presents a flush exterior surface when seated within the module cavity 132 such that the visible appearance of the carrier is substantially uninterrupted by the presence of the Mótus™ pod.

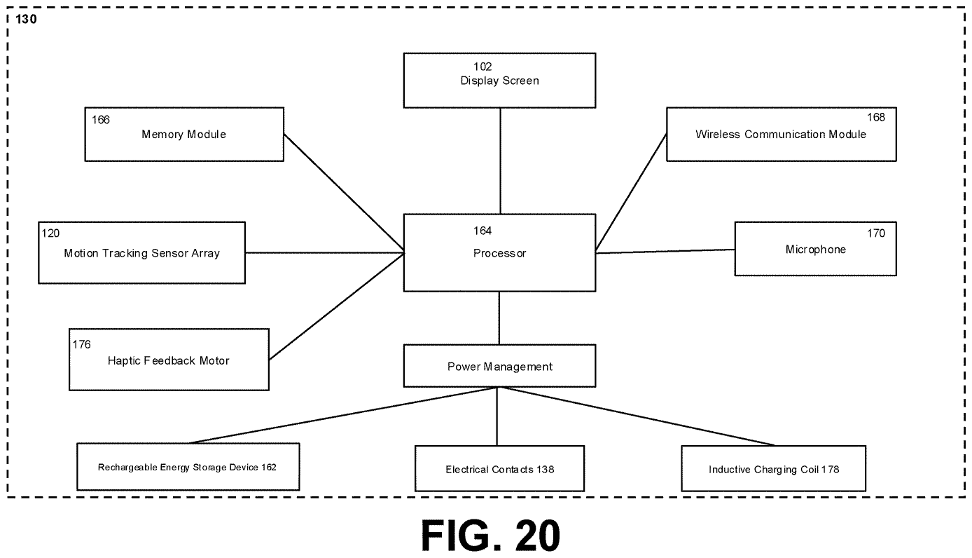

Referring further to FIG. 20, which is a schematic block diagram of the internal electronics of the detachable Mótus™ pod 130, the Mótus™ pod houses, within the sealed enclosure, at least a processor 164, a memory module 166, a wireless communication module 168, a motion tracking sensor array 120 or other inertial sensor, and a rechargeable energy storage device 162 (collectively, the “Pod Core Components”), and may further house one or more of: a display screen 102, one or more environmental sensors, an inductive charging coil 178, a contact-pad or pogo-pin charging interface, firmware stored on the memory module 166, a secure identifier or secure element supporting module authentication, a microphone 170, a haptic feedback motor 176, and any other electronics appropriate for the carrier in which the pod is presently installed and for the product tier class of the pod. In a presently preferred embodiment, the Mótus™ pod constitutes a complete wearable computer that may be operated independently of any carrier while retaining the option of installation within any compatible cavity for power, sensing, display, or actuator extension. The Mótus™ pod may further be provided in any of a plurality of tier classes including, without limitation, a Lite tier class, a Pro tier class, a Medical tier class, and a Performance tier class (collectively, the “Tier Classes”), each Tier Class being characterized by a distinct combination of one or more of computing capability, sensor complement, display resolution, energy storage capacity, and ingress protection rating, and each Tier Class being mechanically and electrically compatible with one or more corresponding Tier Classes of module cavity 132.

In a presently preferred commercial embodiment, the processor 164 is implemented as an ultra-low-power microcontroller or system-on-chip in the ARM Cortex-M33, ARM Cortex-M55, ESP32-S3, or Nordic nRF54 class, operating in an approximately 64 MHz to 240 MHz range, with integrated RAM and non-volatile Flash sufficient for firmware, display assets, sensor buffering, cryptographic keys, and event logs. Firmware may execute under FreeRTOS, Zephyr, or an equivalent real-time operating system for multitasking, radio stack coordination, sensor fusion, and over-the-air update management, while lower-tier embodiments may employ bare-metal firmware. The motion tracking sensor array 120 preferably comprises a six-axis or nine-axis inertial measurement unit including an accelerometer and gyroscope, optionally with magnetometer, barometric pressure sensor, or temperature sensor, and is configured with selectable sample rates of about 50 Hz to 200 Hz for ordinary gait and activity tracking and higher burst sample rates, including about 400 Hz to 1000 Hz, for impact, jump, stomp, or performance classification. The rechargeable energy storage device 162 is preferably a rechargeable lithium-polymer cell in a sealed pod, with lithium iron phosphate or solid-state cells as alternative embodiments, and may provide approximately 150 mAh to 500 mAh capacity depending on pod tier, yielding about two hours in the present prototype configuration and longer runtimes in production tiers depending on display brightness, wireless duty cycle, and sensor sampling. The pod is preferably user-removable from any compatible carrier but sealed and not user-openable, with internal battery or component replacement performed as a service-replaceable operation.

In a presently preferred communications and charging embodiment, the wireless communication module 168 is implemented as a single combo radio or system-on-chip supporting Bluetooth Low Energy, preferably Bluetooth 5.2 or later, with optional Wi-Fi, Wi-Fi Direct, and ultra-wideband support in higher-tier embodiments. The pod antenna may be positioned along a pod perimeter, upper housing region, or carrier-facing keep-out region selected to reduce interference from the rechargeable energy storage device 162, the inductive charging coil 178, and conductive carrier structures. The inductive charging coil 178 may be implemented as a Qi-compatible or proprietary inductive interface and may operate at approximately 1 W to 5 W for pod charging, while spring-loaded pogo-pin contacts or flat contact pads remain preferred for reliable carrier-to-pod power and data exchange when the pod is seated within an active carrier cavity.

### The Module Cavity and Socket Interface

The module cavity 132, alternatively referred to herein as a socket, is in one or more embodiments treated as a core structural and electrical interface of the invention and is not limited to use as a housing for a display. The module cavity 132 may be embodied as a flush-fit recessed cavity integrated into a footwear structure, a wristband, a wristwatch case or strap, an ankle band, a clip-on body, a standalone cradle, or a rehabilitative or medical wearable structure such as a brace, sleeve, orthosis, or post-operative compression garment. Each such embodiment of the module cavity 132 shares a common interface geometry and a common electrical pinout such that a single Mótus™ pod may be received within any compatible module cavity 132 without modification, and such that all Mótus™ pods of a given tier class are interchangeable across all module cavities 132 of that same tier class.

### Modular Cavity and Socket Architecture

The module cavity 132 may be configured with one or more alignment or mating features selected from one or more of rails, keying features, alignment features, recesses, lips, grooves, or shaped mating surfaces, and with a retention system selected from one or more of: longitudinal rails that engage corresponding rails on the Mótus™ pod; mechanical latches operable by a user-actuated lever or button; one or more permanent magnets or electromagnets disposed in opposing relation to corresponding magnetic elements on the Mótus™ pod; spring clips that bear against the Mótus™ pod once seated; elastomeric gaskets that provide friction fit and that further seal the interface against ingress of moisture and particulates; pure friction fit through dimensional tolerance control; and hybrid retention combining two or more of the foregoing (the foregoing retention options being collectively referred to herein as the “Retention Mechanisms”). The retention system is preferably configured to retain the Mótus™ pod securely against the forces encountered during ordinary use of the carrier into which the module cavity 132 is integrated while permitting tool-free removal by the user.

In a presently preferred cavity embodiment, the alignment features 134 and attachment mechanism 136 are implemented as a hybrid retention stack comprising chamfered lead-in surfaces, opposed longitudinal rails, a terminal snap or latch feature, and a perimeter gasket. The rails constrain lateral and vertical motion during walking, running, jumping, or impact; the snap or latch provides positive retention at the fully seated position; and the gasket improves environmental sealing while adding controlled friction. Pure friction fit and magnetic retention are retained as alternatives but are not the preferred primary retention mechanism for athletic or medical-adjacent use cases.

The module cavity 132 is in one or more embodiments configured to receive a removable or swappable electronics module, including without limitation any Mótus™ pod of differing generation, tier class, or feature set, and may further be configured to receive a decorative or passive cavity insert, including without limitation the non-functional decorative insert 144 described elsewhere herein, when no active Mótus™ pod is installed. The module cavity 132 may further be configured as a sealed or protected cavity, comprising one or more of a gasket, a compliant lip, a flexible cover, and a conformal coating disposed at or near the cavity perimeter. The foregoing sealing structures are optional carrier-side support features and do not alter the core removable-pod architecture.

The module cavity 132 is in one or more embodiments offered in any of the Tier Classes, each such Tier Class providing a distinct combination of one or more of cavity depth, cavity area, electrical pinout, charging capability, retention force, and ingress protection rating, and each such Tier Class being mechanically and electrically compatible with the corresponding Tier Class of Mótus™ pod. The module cavity 132 may further be structurally configured to support electronic subsystems including, without limitation, a battery, a processor, one or more displays, one or more inertial measurement units, one or more wireless communication components, and one or more charging systems, whether such subsystems are housed within the Mótus™ pod received within the module cavity 132, integrated permanently into the module cavity 132 itself or its housing, or within or supported by a carrier, or distributed between any of them.

### Multi-Carrier Wearable Ecosystem

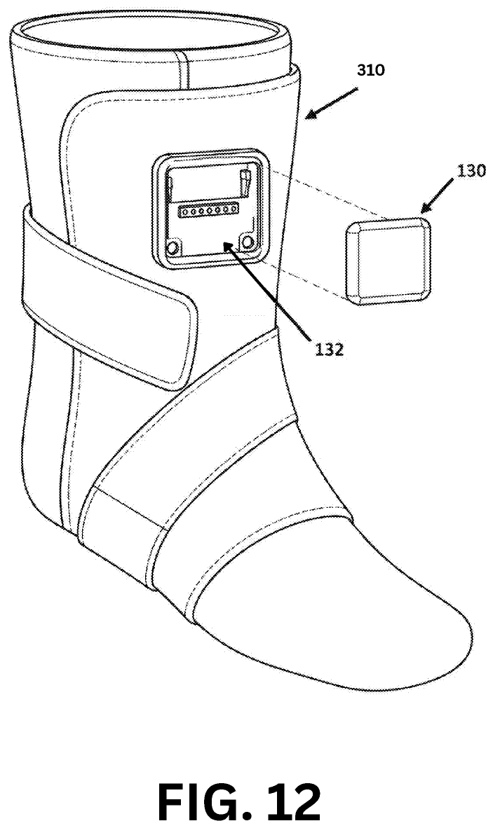

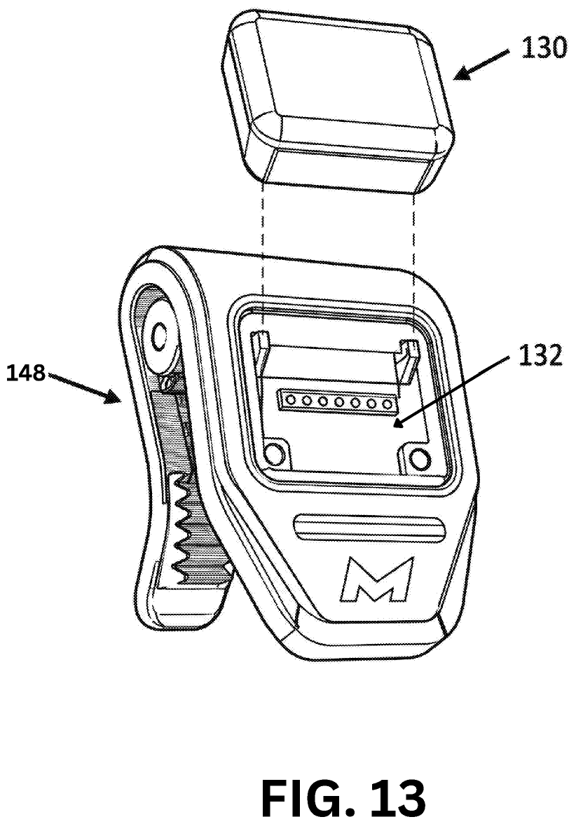

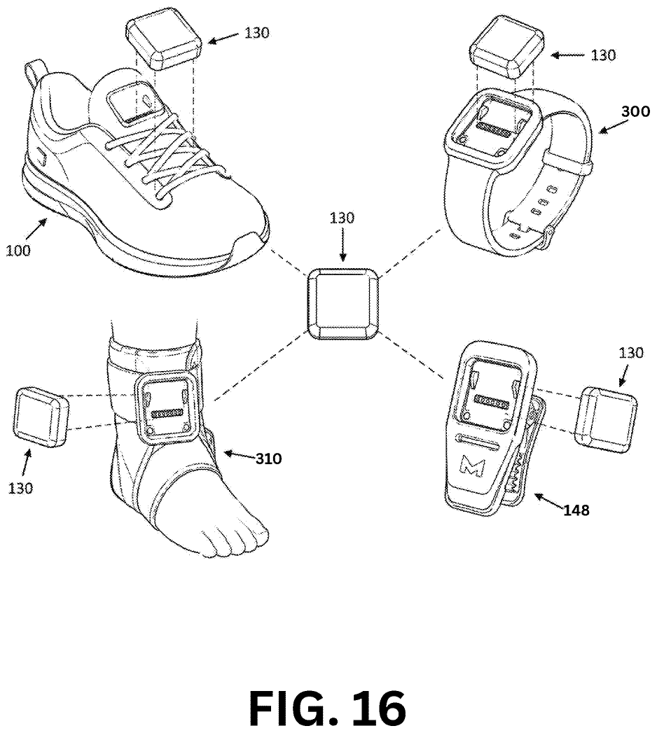

Referring to FIG. 16, an ecosystem view is illustrated showing a Mótus™ pod 130 operating across a plurality of compatible carriers including, without limitation, a footwear carrier 100, a wristband or wristwatch carrier 300, a rehabilitation or medical-adjacent carrier 310, and a clip carrier 148. In one or more embodiments, the Mótus™ pod is configured to operate, without modification, in any one of a plurality of compatible carriers. The plurality of compatible carriers includes, without limitation: a footwear carrier, in which the Mótus™ pod is received within a module cavity 132 formed within the tongue, sole, side panel, or other region of a smart footwear body 100; a wristband or wristwatch carrier, in which the Mótus™ pod is received within a corresponding module cavity 132 formed within a wristband or a watch strap and is worn upon the wrist of the user; an ankle band carrier, in which the Mótus™ pod is received within a corresponding module cavity 132 formed within an ankle band and is worn about the ankle of the user; a clip-on carrier such as the clip accessory 148 as illustrated in FIG. 13, in which the Mótus™ pod is received within a corresponding module cavity 132 formed within a clip body and is releasably attached to clothing, a belt, a bag strap, a backpack, or another personal item; a standalone carrier, in which the Mótus™ pod is received within a self-supporting cradle, case, or fob and is carried by the user independently of any worn article; and a rehabilitative or medical-adjacent wearable carrier 310 as illustrated in FIG. 12, in which the Mótus™ pod is received within a corresponding module cavity 132 formed within a brace, sleeve, orthosis, prosthesis, post-operative compression garment, or other medical-adjacent wearable structure and is worn for monitoring, coaching, adherence, movement intelligence, gait or asymmetry tracking, balance screening, return-to-walk progression, clinician workflow support, home exercise engagement, or similar purposes. The foregoing carriers, together with any other carrier providing a module cavity 132 that conforms to the standardized cavity and socket interface disclosed herein, are collectively referred to herein as the “Compatible Carriers,” and reference herein to a “Compatible Carrier” means any one of the Compatible Carriers.

Each said carrier provides a module cavity 132 that mechanically retains the Mótus™ pod by way of any of the attachment mechanisms 136 described herein and that establishes electrical interconnection with the Mótus™ pod by way of electrical contacts 138 analogous in form and function to those described herein. The Mótus™ pod is configured to detect the type of carrier to which it is presently coupled by means of one or more of: identification contacts among the electrical contacts 138 that present a carrier-specific identifier to the pod; near-field communication or radio-frequency identification interrogation of an identifier element disposed within the carrier; gesture, motion, or orientation patterns characteristic of the carrier as detected by the motion tracking sensor array 120; and a value reported by the carrier through a data communication channel established over the electrical contacts 138 or a wireless link (the foregoing detection means being collectively referred to herein as the “Carrier-Detection Mechanisms”). Upon detecting the carrier type, the Mótus™ pod, alone or in cooperation with Reflexion OS, configures its operating parameters, user-interface presentation, sensor duty cycles, communication behavior, and assigned device role in accordance with the detected carrier. In one or more embodiments, one or more of the plurality of compatible carriers is provided as a passive carrier comprising the module cavity 132, one or more alignment features 134, and an attachment mechanism 136 sufficient to mechanically retain the Mótus™ pod 130 within the module cavity 132, without further comprising electrical contacts 138, electrical power exchange, data communication exchange, supplementary sensors, or other electrically active elements; such passive carriers include, by way of non-limiting example, certain clip-on carriers, lanyard carriers, standalone fashion carriers, and decorative carriers in which the Mótus™ pod 130 is mechanically retained but operates wirelessly through its onboard wireless communication module 168 and is powered by its onboard rechargeable energy storage device 162.

In a presently preferred carrier-detection embodiment, each electrically active carrier includes a dedicated carrier-identification contact or group of contacts within the electrical contacts 138. The carrier-identification feature may be implemented as a resistor-coded identifier, a one-wire digital identifier, an I2C or SPI peripheral identifier, a secure element, or another carrier-side memory or authentication circuit that reports carrier type, carrier tier, left-side or right-side designation where applicable, and authorization state to the Mótus™ pod. Near-field communication, radio-frequency identification, and motion-orientation inference may be used as secondary or fallback mechanisms, but the preferred initial carrier detection path is electrical carrier-ID through the standardized contact interface when such contacts are present.

### Electrical Interface and Charging Embodiments

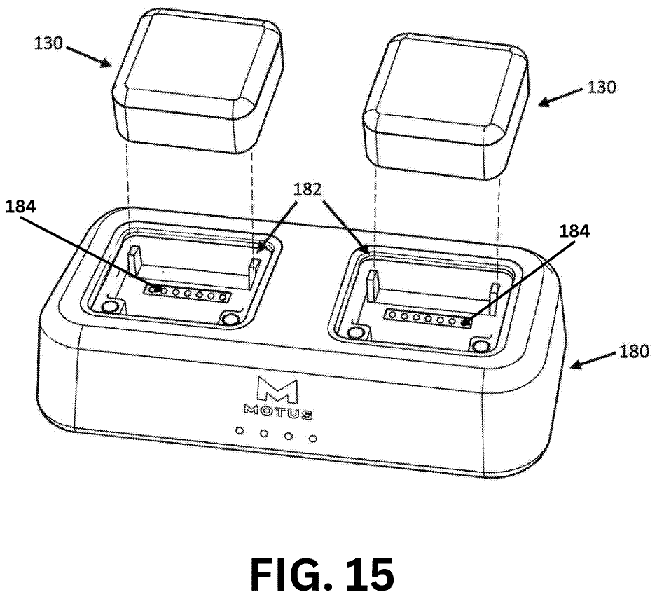

Referring to FIG. 15, a charging dock 180 is illustrated, the charging dock 180 being configured to removably receive one or more Mótus™ pods 130 within respective dock pod bays 182 and being further configured to provide one or more of mechanical alignment, electrical charging, data communication, and firmware update through dock electrical contacts 184. In one or more embodiments, electrical interconnection between the Mótus™ pod and the module cavity 132 may be effected by way of any one or more of the following charging interfaces (collectively, the “Charging Interfaces”): a plurality of spring-loaded pogo-pin contacts mating with corresponding contact pads on the opposing surface; a plurality of flat contact-pad interfaces bearing against corresponding contact pads under spring load; a wireless inductive charging interface in which a charging coil disposed within the module cavity 132 is positioned in inductive opposition to a corresponding inductive charging coil disposed within the Mótus™ pod, in accordance with the Qi standard or any other compatible wireless-power standard; and a dock-assisted charging interface in which one or both of the Mótus™ pod and the carrier into which it is installed is configured to be received within a docking station that provides one or more of mechanical alignment, electrical charging, data communication, and firmware update.

The modular wearable system is in one or more embodiments configured to perform hot-swap detection of the Mótus™ pod by monitoring one or more dedicated detection contacts among the electrical contacts 138 and to transition components into safe operational states upon detection of insertion or removal of the Mótus™ pod from any compatible module cavity 132. Automatic synchronization of stored sensor data, user profile data, firmware, and configuration between the Mótus™ pod and the carrier, between two or more Mótus™ pods worn by the same user, and between any such Mótus™ pod and a paired companion device 200 or cloud-hosted service 202, may be initiated automatically upon insertion of the Mótus™ pod from any compatible module cavity 132.

### Standardized Mechanical Alignment Geometry and Electrical Contact Pattern

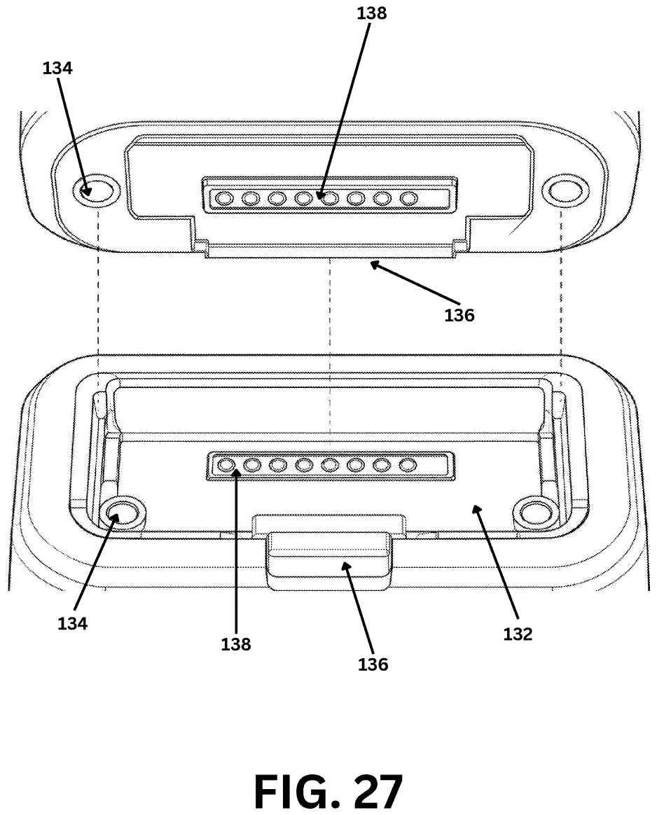

Referring to FIG. 27, in certain embodiments, the standardized carrier interface may include a standardized mechanical alignment geometry and a standardized electrical contact pattern.

The standardized mechanical alignment geometry may include guide rails, guide posts, alignment holes, keyed surfaces, recesses, ribs, perimeter features, detents, latch features, gasketed surfaces, or combinations thereof. These features may position the removable Mótus™ pod in a repeatable orientation within different carrier types.

The standardized electrical contact pattern may include, in one embodiment, a linear eight-contact arrangement positioned on a mating face of the Mótus™ pod and a corresponding mating face of the carrier cavity. The contacts may include, for example, power, ground, charging detection, data, clock, carrier identification, accessory detection, and reserved or future expansion contacts.

Other contact counts, contact arrangements, pin assignments, or contact geometries may also be used, provided that the pod and carrier share a compatible standardized mating pattern. This allows the same Mótus™ pod architecture to operate across footwear carriers, detachable tongue carriers, wrist carriers, clip carriers, glove carriers, ankle carriers, and other compatible carrier types.

### Module Authentication and Identification

The modular wearable system is further configured, in one or more embodiments, to perform module authentication of the Mótus™ pod through the electrical contacts 138 of the module cavity 132, by way of one or more of: a digital identification pin presenting a static or rolling carrier-specific identifier; a secure element challenge-response exchange in which the Mótus™ pod and the carrier each prove possession of a shared cryptographic key without disclosure of the key itself; an identifier transmitted by near-field communication or radio-frequency identification between an identifier element disposed within the carrier and a corresponding reader disposed within the Mótus™ pod; and biometric authentication based upon gait signatures or other motion biometrics detected by the motion tracking sensor array 120. The modular wearable system may verify the identity, tier class, firmware version, and authorization status of the Mótus™ pod and the carrier before establishing operative coupling, and may withhold one or more functions, including, without limitation, charging, data transfer, firmware update, and access to paired services, in the event that authentication fails.

### Carrier Detection

In certain embodiments, the Mótus™ pod may identify the carrier type through a carrier identification pathway. The carrier identification pathway may include a dedicated identification contact, a contact signature, resistor value, memory element, NFC tag, RFID tag, electronic identifier, or other carrier-specific identification structure.

Orientation and motion patterns may also be used as a secondary or corroborating method of carrier detection. For example, motion patterns associated with a foot, wrist, clip, glove, tongue carrier, or other carrier may help confirm or supplement the carrier identification detected through the electrical, NFC, RFID, or electronic identification pathway.

Accordingly, orientation and motion-based detection need not be the sole carrier detection method and may operate together with one or more physical, electrical, or electronic identification features.

### Reflexion OS Platform

As used herein and in the appended claims, the term “wearable operating system” refers to a software framework, of which Reflexion OS is one preferred embodiment, that executes on one or more of a Mótus™ pod, a companion device 200 wirelessly paired with one or more Mótus™ pods, and a cloud-hosted service 202, and that coordinates the exchange of data, control signals, and visual content among such devices. The recited operations of the wearable operating system are performed by said software framework executing on said devices, and references herein to the wearable operating system encompass any such software framework having the recited functionality, regardless of branding or specific implementation.

Reflexion OS is configured to coordinate operation among one or more Mótus™ pods worn by a user. Reflexion OS is configured to: detect the type of carrier presently coupled to each said Mótus™ pod, the carrier being any one of the Compatible Carriers; detect the left-side or right-side orientation of each said Mótus™ pod by way of one or more of orientation data reported by the motion tracking sensor array 120, identification contacts unique to a left-side or right-side module cavity 132, and user designation; and dynamically assign device roles to each said Mótus™ pod, the device roles (collectively, the “Device Roles”) including, without limitation, primary display, secondary display, primary sensor source, secondary sensor source, audio source, gesture controller, game-input controller, and care workflow source.

When conflicting carrier types are present, Reflexion OS preferably applies a deterministic device-role assignment policy. Authenticated carrier identity and saved device assignment are evaluated first, followed by explicit user or administrator assignment, then sensor-based confirmation, and finally a user prompt if the state remains ambiguous. In a configuration having two foot-mounted Mótus™ pods and one wrist-mounted Mótus™ pod, the foot-mounted pods are preferably assigned primary gait, foot-strike, foot-lift, jump, stomp, kick, and bilateral motion-classification roles, while the wrist-mounted pod is assigned primary display, notification, user-interface, or secondary physiological-sensing roles. Left-foot and right-foot orientation is preferably distinguished at startup by a combination of left/right carrier-cavity identifier, stored pod-to-carrier pairing, pod serial or secure identifier, and IMU/gait-phase confirmation. During first-time pairing without prior user designation, Reflexion OS may request a simple calibration sequence, such as tapping or stepping with the left foot and then the right foot, and may confirm the assignment using mirrored orientation, alternating gait phase, plantar pressure timing, or other bilateral sensor signals before locking the left/right roles for the session.

Reflexion OS is further configured to synchronize motion telemetry across the one or more Mótus™ pods worn by the user, the motion telemetry comprising one or more Motion Events, the term “Motion Events” referring herein to classes of user movement detected and reported by one or more Mótus™ pods, including, without limitation, step events, jump events, stomp events, kick events, gesture events, foot-strike events, foot-lift events, and game-input events, and to process the synchronized motion telemetry into coordinated outputs spanning the displays, light indicators, haptic actuators, audio outputs, companion-device interfaces, and cloud-connected outputs of the ecosystem. As used herein, references to Reflexion OS dynamically configuring or modifying operation of the detachable electronics module in response to a detected carrier type include, without limitation, modifying user-interface presentation through one or more output modalities of the detachable electronics module or of the carrier to which the detachable electronics module is presently coupled, including a display screen where present, a haptic feedback motor, an audio output, an indicator light, a companion device, or a cloud-hosted interface. Reflexion OS may further expose application programming interfaces, software development kits, and integration endpoints to first-party and authorized third-party developers in present or future embodiments.

Communication between any Mótus™ pod and Reflexion OS may be conducted over any suitable wireless protocol, including, without limitation, Bluetooth, Bluetooth Low Energy, Wi-Fi, Wi-Fi Direct, ultra-wideband, near-field communication, or proprietary radio-frequency protocols (collectively, the “Wireless Protocols”). Encrypted authentication mechanisms may be employed to ensure that only authorized companion devices may exchange data with a Mótus™ pod, and biometric authentication based upon gait signatures or other motion biometrics detected by the motion tracking sensor array 120 may be employed as an additional or alternative authentication factor.

In a presently preferred protocol embodiment, pod-to-pod synchronization over wireless synchronization path 250 is performed using Bluetooth Low Energy secure connections, either directly between pods or through a companion device 200 acting as a relay, with time-stamped motion events exchanged at intervals sufficient for gait, stomp, hop, game-input, and session synchronization. Pod-to-companion-device communication is preferably performed using Bluetooth Low Energy for pairing, control, and real-time telemetry, with Wi-Fi or Wi-Fi Direct available in higher-tier embodiments for bulk data transfer, firmware update, or media synchronization. Ultra-wideband may be used as an optional ranging or proximity channel rather than as the primary telemetry channel. Security preferably includes Bluetooth LE Secure Connections, encrypted link-layer communication such as AES-CCM where supported, application-layer session keys for sensitive data, signed firmware updates, and TLS-protected communication between the companion device 200 and any cloud-hosted service 202.

### System-Level Data Flow and Connectivity

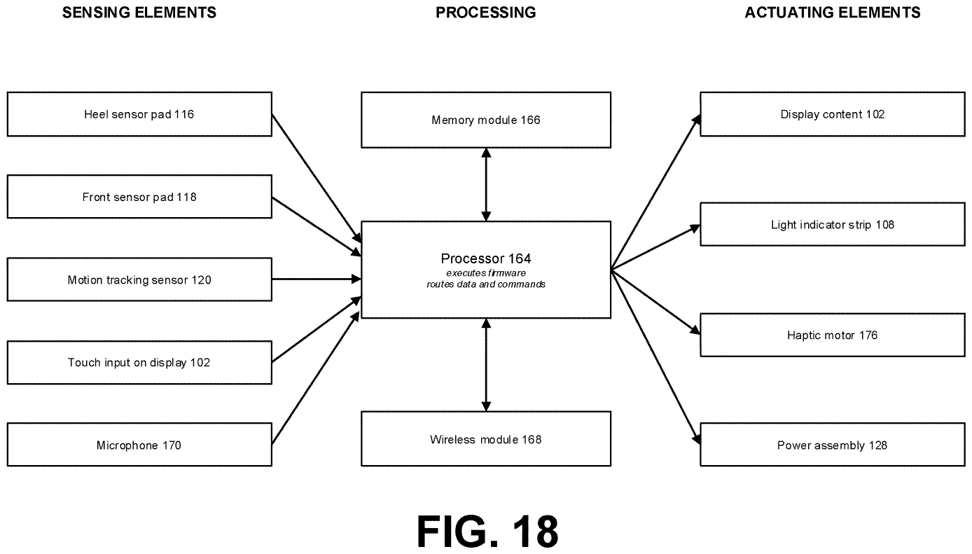

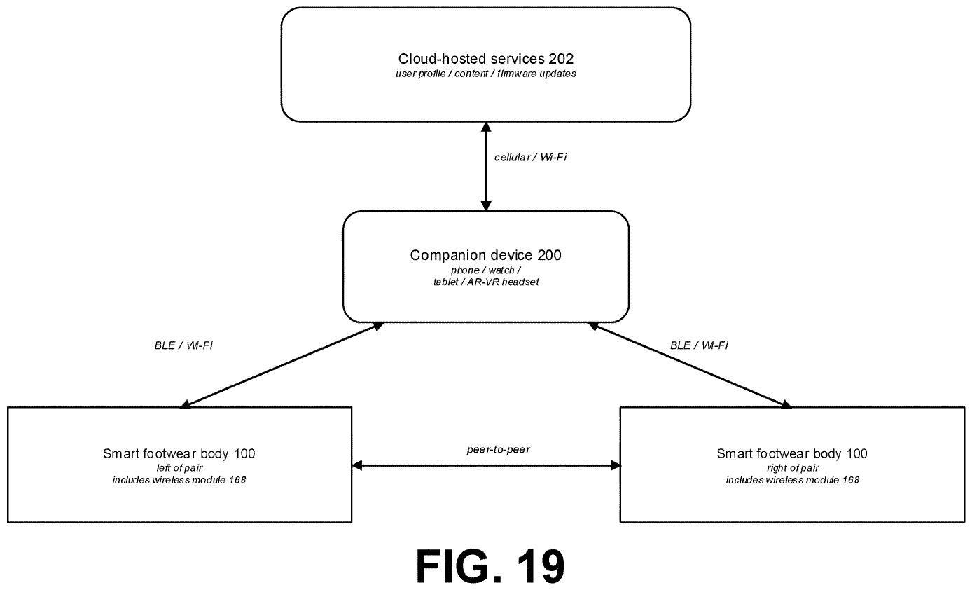

Referring to FIG. 18 and FIG. 19, the modular wearable system exhibits a common data-flow and connectivity architecture that applies to a Mótus™ pod installed within, or operating in association with, any one of the Compatible Carriers, independent of the particular carrier presently coupled to the pod. Within the pod, the processor 164 receives input signals from one or more sensors, including the motion tracking sensor array 120, any environmental sensors housed within the pod, and any supplementary sensors provided by a carrier and communicated over the electrical contacts 138; executes firmware stored in the memory module 166 to compute activity, motion, orientation, and event data therefrom; and issues output commands to one or more output modalities, including a display screen 102 where present, a haptic feedback motor 176, an audio output, an indicator light of the carrier, and any supported carrier-side output coupled over the electrical contacts 138. FIG. 18 depicts this sensing, processing, and output architecture in a smart footwear implementation as one representative example; in other Compatible Carriers, the carrier-specific sensing and output elements differ while the pod-side processing architecture remains the same.

The wireless communication module 168 of the pod maintains bidirectional communication, over any of the Wireless Protocols, with one or more other Mótus™ pods worn by the user, with a companion device 200, and, through the companion device 200, with one or more cloud-hosted services 202, under coordination of the wearable operating system. FIG. 19 depicts this connectivity in a smart footwear implementation as one representative example; the same pod-to-pod, pod-to-companion-device, and companion-device-to-cloud connectivity applies to a Mótus™ pod installed within any Compatible Carrier, including a wristband or wristwatch carrier 300, an ankle band carrier, a clip carrier 148, a glove or hand-worn carrier 330, a standalone carrier, or a rehabilitative or medical-adjacent carrier 310, regardless of the carrier in which the pod is installed.

### Haptic Feedback Architecture

Haptic feedback in the modular wearable system is performed by one or more haptic feedback motors 176, the location of which depends on the embodiment. In one or more embodiments, a haptic feedback motor 176 is housed within the detachable Mótus™ pod 130, in which case the haptic feedback motor 176 provides tactile feedback at whatever carrier the detachable Mótus™ pod 130 is presently installed within. In one or more further embodiments, a carrier-side haptic feedback motor 176 is integrated into a compatible carrier and is commanded by the Mótus™ pod 130 or Reflexion OS through the standardized interface.

Regardless of the location of the haptic feedback motor 176, the tactile pattern delivered by the haptic feedback motor 176 is commanded by the processor 164 of the detachable Mótus™ pod 130 under control of the wearable operating system. By way of non-limiting example, the wearable operating system may command the haptic feedback motor 176 to deliver a selected tactile pattern in coordination with one or more of: notifications received from a paired companion device 200 or from a cloud-hosted service 202; turn-by-turn navigation prompts; motion events classified by the motion-event classification framework disclosed herein, including, without limitation, steps, stomps, hops, kicks, gesture events, and game-input events; mode-switching events; module-authentication events; and operating-system alerts. Where the haptic feedback motor 176 is located in the smart footwear body 100 rather than in the detachable Mótus™ pod 130, the haptic command is delivered from the processor 164 of the detachable Mótus™ pod 130 to the haptic feedback motor 176 by way of the electrical contacts 138 of the module cavity 132 and the embedded device power assembly.

The wearable operating system may further forward a haptic command originating at one carrier worn by the user to a haptic feedback motor 176 located at another carrier worn by the same user. By way of non-limiting example, a notification received at a wrist-mounted detachable Mótus™ pod 130 may be forwarded by the wearable operating system to one or more haptic feedback motors 176 of a smart footwear body 100 worn by the same user for tactile reproduction at the foot; conversely, a motion-event classification or notification originating at a foot-mounted detachable Mótus™ pod 130 may be forwarded to an in-pod haptic feedback motor 176 of a wrist-mounted detachable Mótus™ pod 130 of the same user for tactile reproduction at the wrist. The selection of source motor and destination motor is made by the wearable operating system in accordance with the device roles dynamically assigned to the detachable Mótus™ pods worn by the user as described elsewhere herein.

### Non-Display Pod Embodiments

In one or more further embodiments of the present invention, the detachable Mótus™ pod 130 is provided in a non-display configuration, designated for clarity as a non-display Mótus™ pod 130B. The non-display Mótus™ pod 130B is mechanically and electrically interchangeable with the display-equipped Mótus™ pod across any compatible module cavity 132 of the modular wearable system. References herein to the detachable Mótus™ pod 130 refer generically to the genus of detachable Mótus™ pods that includes both the display-equipped variant and the non-display variant 130B. The non-display Mótus™ pod 130B is configured to operate without an electronic display in the sealed enclosure of the pod, the non-display Mótus™ pod 130B presenting status, telemetry, and user feedback to a wearer through one or more of a haptic feedback motor of the detachable Mótus™ pod, an indicator light of a carrier to which the detachable electronics module is coupled in which the detachable Mótus™ pod is presently installed, and a paired companion device wirelessly paired with the detachable Mótus™ pod.

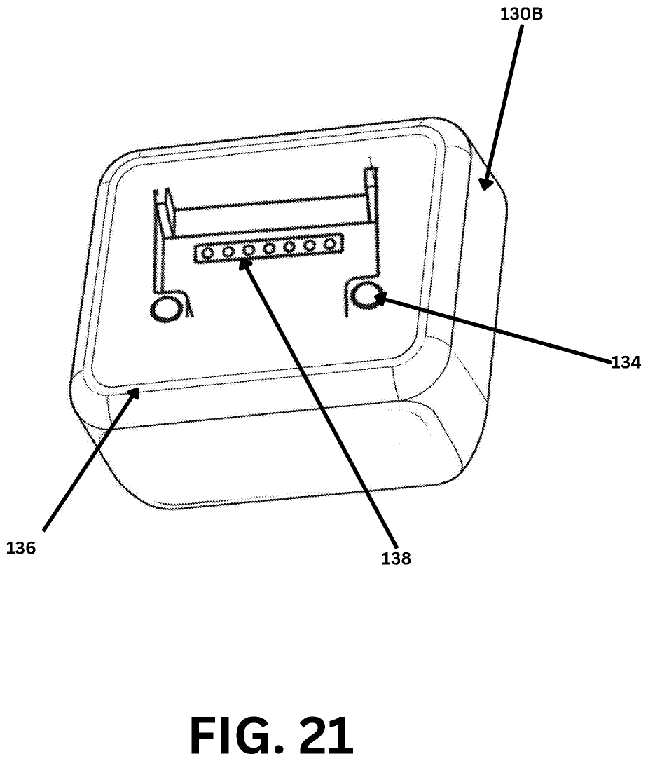

Referring to FIG. 21, the non-display Mótus™ pod 130B comprises the sealed enclosure, the cavity alignment features 134, the module attachment mechanism 136, and the electrical contacts 138 of the detachable Mótus™ pod 130, but is provided without the display screen 102 of the display-equipped Mótus™ pod. The non-display Mótus™ pod 130B may, in various embodiments, be configured as a lower-cost, smaller, more rugged, longer-runtime, sealed-medical, training, institutional, or embedded variant of the detachable Mótus™ pod 130, retaining the same standardized mechanical and electrical interface used by the display-equipped Mótus™ pod.

In a non-display embodiment, the non-display Mótus™ pod 130B may house, within the sealed enclosure, any combination of the processor 164, the memory module 166, the wireless communication module 168, the motion tracking sensor array 120 or other inertial sensor, the rechargeable energy storage device 162, one or more environmental sensors, the inductive charging coil 178, a contact-pad or pogo-pin charging interface, firmware stored on the memory module 166, a secure identifier or secure element supporting module authentication, the microphone 170, the haptic feedback motor 176, an indicator light, or any other electronics appropriate for the carrier in which the non-display Mótus™ pod 130B is presently installed and for the product tier class of the non-display Mótus™ pod 130B.

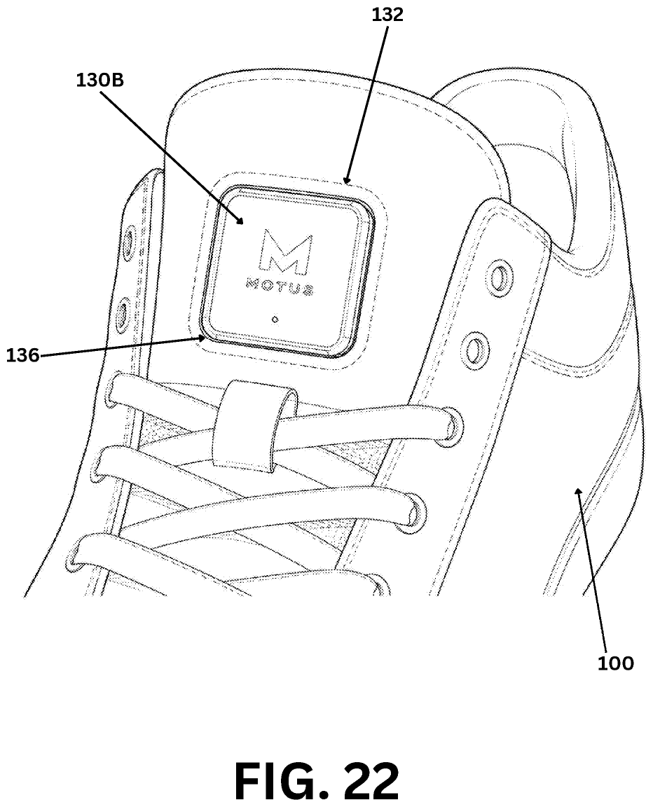

Referring to FIG. 22, in an exemplary embodiment the non-display Mótus™ pod 130B is removably received within the module cavity 132 of the footwear carrier (the smart footwear body 100) in the same manner as the display-equipped Mótus™ pod. The cavity alignment features 134, the module attachment mechanism 136

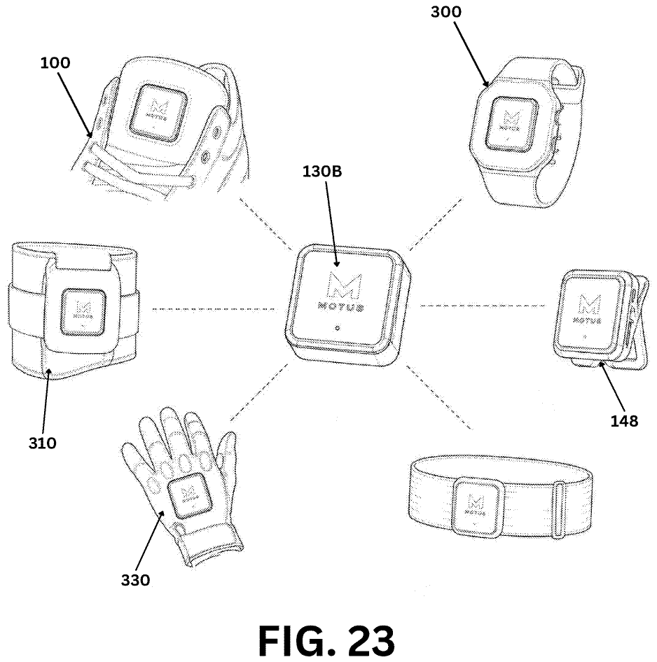

Referring to FIG. 23, the non-display Mótus™ pod 130B is operable in any one of the plurality of compatible carriers disclosed herein, including, without limitation, the footwear carrier 100, the wristband or wristwatch carrier 300, the rehabilitation or ankle-adjacent carrier 310 the clip-on carrier 148, the glove or hand-worn carrier 330, and any other carrier providing a standardized module cavity 132 with the cavity alignment features 134, the module attachment mechanism 136, and the electrical contacts 138 described herein.

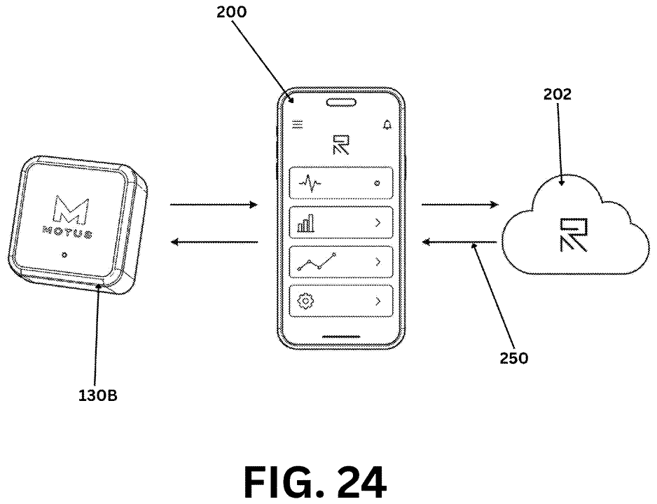

Referring to FIG. 24, in a single-pod non-display embodiment, the non-display Mótus™ pod 130B communicates bidirectionally over a wireless synchronization path 250 with a companion device 200 executing Reflexion OS and with one or more cloud-hosted services 202 in communication with the companion device 200. User interaction with the non-display Mótus™ pod 130B occurs through Reflexion OS executing on the companion device 200, on the cloud-hosted service 202, on a connected wristwatch or other wearable device, or on a combination of the foregoing. User feedback is delivered through one or more of: a visual interface of the companion device 200, an auditory interface of the companion device 200 or of the non-display Mótus™ pod 130B, a haptic interface comprising the haptic feedback motor 176 of the non-display Mótus™ pod 130B, an indicator light of a carrier to which the detachable electronics module is coupled (such as the power light indicator strip 108 of the smart footwear body 100), a remote dashboard, an administrative or clinician-facing system, a therapeutic or rehabilitative system, an educational system, a performance or training system, or a combination thereof. Accordingly, a local electronic display on the non-display Mótus™ pod 130B is not required for operation of the modular wearable system.

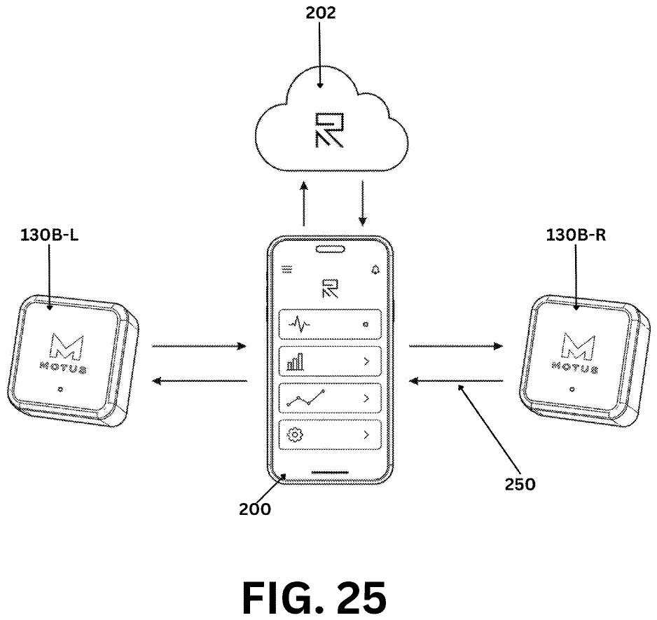

Referring to FIG. 25, in a dual-pod non-display embodiment, a pair of non-display Mótus™ pods, designated 130B-L (left) and 130B-R (right), communicate wirelessly over the wireless synchronization path 250 with the companion device 200 executing Reflexion OS and with the cloud-hosted service 202. The non-display Mótus™ pods 130B-L and 130B-R further communicate with one another, either directly or through the companion device 200 acting as a relay, for paired-pod motion classification and for left-side/right-side role assignment as disclosed elsewhere herein. Dual-pod non-display embodiments support left-side and right-side role assignment, movement telemetry synchronization, gait and activity comparison, bilateral movement analysis, training, rehabilitation support, game input, and other coordinated functions in the same manner as dual-pod display-equipped embodiments.

The same standardized module cavity 132, cavity alignment features 134, module attachment mechanism 136, electrical contacts 138, and Reflexion OS coordination architecture may support both display-equipped Mótus™ pods and non-display Mótus™ pods. Accordingly, display-equipped and non-display embodiments may be deployed interchangeably within the same modular wearable system, subject to physical compatibility, electrical compatibility, software configuration, and access or policy rules implemented by Reflexion OS. In a mixed-embodiment configuration, a display-equipped Mótus™ pod may operate as a user-facing interface in one carrier while one or more non-display Mótus™ pods operate as sensor, movement, control, or telemetry modules in one or more other carriers worn by the same user, with Reflexion OS assigning device roles among the pods in accordance with pod capability, carrier type, user preference, session type, battery state, sensor state, and other system context.

In one or more non-display embodiments, the non-display Mótus™ pod 130B is configured to operate autonomously, collecting sensor data, processing the sensor data through the processor 164, communicating with Reflexion OS, communicating with one or more other Mótus™ pods, synchronizing with one or more connected devices, and executing stored instructions from the memory module 166, without requiring direct user interaction with the non-display Mótus™ pod 130B itself. The non-display Mótus™ pod 130B may store telemetry, calibration data, device identity data, activity history, firmware instructions, and configuration data locally on the memory module 166 and may later synchronize the stored information with Reflexion OS through the companion device 200, the cloud-hosted service 202, a charging dock 180, or another connected system.

### Smart Footwear Implementation of the Modular Wearable System

The following description sets forth a smart footwear implementation of the modular wearable system disclosed herein. The smart footwear implementation comprises a smart footwear body 100, alternatively referred to herein as the footwear carrier, that includes or supports a module cavity 132 sized and shaped to removably receive a Mótus™ pod. The footwear carrier may be substantially passive, or may include carrier-side support structures such as retention features, electrical contacts, status indicators, or charging circuitry. Persons skilled in the art will appreciate that the core invention remains centered on the Mótus™ pod, the standardized cavity-and-carrier architecture, and Reflexion OS coordination.

### Overview of the Smart Footwear Body

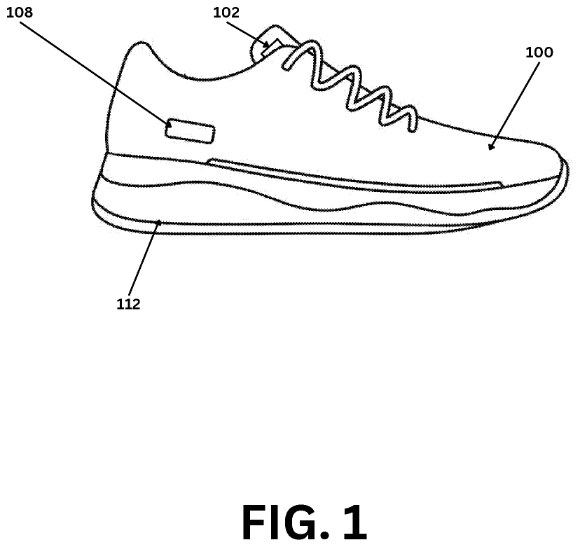

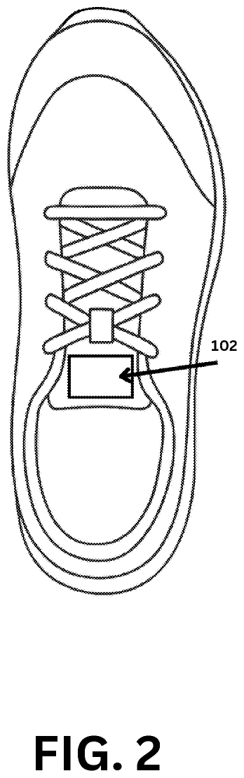

Referring now to FIGS. 1-3, a smart footwear article 100 is illustrated according to one embodiment of the present invention. The smart footwear body 100 provides a wearable carrier structure for receiving, retaining, protecting, charging, or communicating with the Mótus™ pod. The smart footwear body 100 may be constructed from materials commonly employed in athletic and lifestyle footwear, including woven textile uppers, knit synthetic uppers, thermoplastic polyurethane reinforcements, leather, suede, mesh panels, and combinations thereof. The footwear body may be secured to a foot using conventional laces, straps, hook-and-loop closures, elastic structures, magnetic closures, or other suitable footwear closure mechanisms.

The smart footwear body 100 may be manufactured in a range of sizes corresponding to standard adult and youth foot sizing, and may be manufactured in left-foot and right-foot configurations as conventional in the art. Internal cavities, channels, and mounting surfaces may be formed within the smart footwear body 100 during manufacture to receive and retain the electronic and mechanical components described below without compromising the structural integrity, comfort, or aesthetic appearance of the article of footwear.

### Display-Equipped Pod and Optional Carrier Display

In display-equipped embodiments, a display screen 102 may be provided as part of the Mótus™ pod 130 or, in alternate embodiments, as a carrier-side display coupled to the Mótus™ pod through the standardized interface. The display screen 102 may present dynamic digital information to the wearer or to a third party observing the carrier. In one preferred display-equipped embodiment, the display screen 102 comprises an AMOLED or OLED display, although alternative display technologies may be employed.

Where the display screen 102 is housed within the Mótus™ pod 130, the display is operatively coupled to the processor 164 and memory module 166 of the pod. Where the display screen 102 is carrier-side, the display may be driven by the Mótus™ pod through the electrical contacts 138 or another electrical interface. In non-display embodiments, the Mótus™ pod omits the local display and presents status, telemetry, and user feedback through Reflexion OS, haptic output, audio output, light indicators, companion devices, or cloud-connected interfaces.

### Carrier-Side Charging Interfaces

In one or more embodiments, charging of the Mótus™ pod is provided through the module cavity 132, the detachable tongue assembly 140, a docking station, or another compatible carrier having electrical contacts, contact pads, pogo pins, or an inductive charging coil configured to interface with corresponding charging structures of the Mótus™ pod. Where a footwear carrier includes an exterior charging feature, the feature may be implemented as a carrier-side charging interface rather than as a required component of every embodiment.

Carrier-side charging interfaces may include contact pads, pogo-pin contacts, inductive charging coils, magnetic alignment structures, or a detachable tongue assembly configured to charge a Mótus™ pod while the pod is docked in the module cavity. Such charging structures are optional carrier features and may supplement, but need not replace, charging structures housed within the Mótus™ pod itself.

### Power Light Indicator Strip

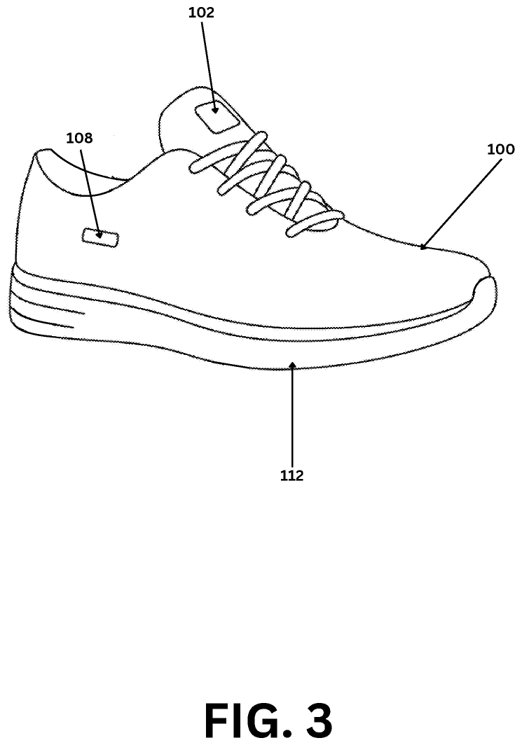

Referring to FIG. 1 and FIG. 3, a power light indicator strip 108 extends laterally along an exterior surface of the smart footwear body 100. The power light indicator strip 108 comprises one or more light-emitting elements, preferably comprising an array of addressable light-emitting diodes (LEDs), arranged in a linear or curvilinear pattern along an outer side of the smart footwear body 100. The power light indicator strip 108 may further include a transparent or translucent cover that diffuses light emitted by the light-emitting elements.

The power light indicator strip 108, where present, is operatively coupled to the processor 164 of the detachable Mótus™ pod 130 by way of the electrical contacts 138 of the module cavity 132 or by way of another carrier-side interface. The power light indicator strip 108 is configured to present status information, including battery status, pairing status, session status, notification status, or carrier state, under control of the Mótus™ pod or Reflexion OS.

### Optional Carrier-Side Support Electronics

In embodiments where the footwear carrier includes carrier-side electronics, such electronics may be limited to support components associated with the standardized module cavity, including identification circuitry, charging contacts, a simple status indicator, or wiring between the cavity and a carrier-side power source. In other embodiments, the footwear carrier is substantially passive and the Mótus™ pod contains the primary processor, memory, sensors, wireless communication module, and rechargeable energy storage device.

To avoid duplication with the Mótus™ pod 130, any carrier-side electronics preferably operate as interface and support circuitry rather than as a second full wearable computer. In the preferred architecture, principal computing, wireless communication, session identity, sensing, and rechargeable energy storage are housed in the removable Mótus™ pod 130, while carrier-side electronics, if present, support functions such as contact routing, carrier identification, charging, status indication, or supplemental sensor coupling.

### Shock Absorption Midsole and Outer Sole Grip Surface

The footwear carrier may include conventional footwear components, including a shock absorption midsole 112, outer sole grip surface 114, cushioning layers, tread features, and other structural shoe components. These footwear structures support ordinary comfort, traction, and durability functions and are not required to house the primary electronics of the modular wearable system.

An outer sole grip surface 114 may be positioned beneath the footwear carrier to provide traction and ordinary ground-contacting shoe functionality. The outer sole grip surface may comprise tread features, rubber compounds, thermoplastic elastomers, or other conventional sole materials. The outer sole grip surface is not required to contain the primary electronics of the modular wearable system.

### Pod Sensors and Optional Carrier-Side Sensors

The Mótus™ pod 130 may house the primary motion tracking sensor array 120 or other inertial sensor used for steps, gait, cadence, impact, gesture, and movement classification. In certain carrier embodiments, optional carrier-side sensors, such as pressure sensors or contact-detection sensors, may be electrically coupled to the Mótus™ pod through the standardized interface to provide supplemental context.

Data acquired from the pod sensors and any optional carrier-side sensors may be processed on the Mótus™ pod 130, by Reflexion OS on a companion device 200, by one or more cloud-hosted services 202, or by a combination of the foregoing.

### Optional Carrier-Side Power and Interface Assembly

In a further embodiment, the footwear carrier includes a carrier-side power and interface assembly arranged to route electrical power or data between the module cavity 132 and one or more optional carrier-side components. The carrier-side power and interface assembly may include wiring, flex circuitry, protection circuitry, contact pads, a charge controller, an inductive charging coil, or a supplemental battery housed in the detachable tongue assembly 140.

The carrier-side power and interface assembly may receive energy from a docking station, inductive charging surface, contact-pad charging interface, pogo-pin charging interface, or battery-integrated detachable tongue assembly, and may deliver conditioned electrical energy to the Mótus™ pod 130 through the electrical contacts 138 while the pod is seated in the module cavity 132. The assembly may also distribute power from the Mótus™ pod 130 to optional carrier-side status indicators or supplemental sensors.

In the smart footwear embodiment, the rechargeable energy storage device 162 housed within the detachable Mótus™ pod 130 serves as the principal battery of the modular wearable system unless a particular carrier is expressly described as including a supplemental carrier-side battery. References herein to power supplied from the footwear body or tongue assembly should be understood as optional carrier-side support for charging, status indication, or auxiliary functions, rather than as a requirement that the shoe contain the primary battery independently of the Mótus™ pod.

### Data Flow and Operative Interconnection

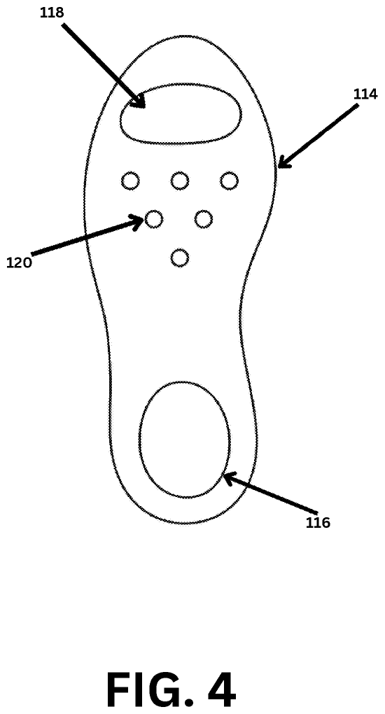

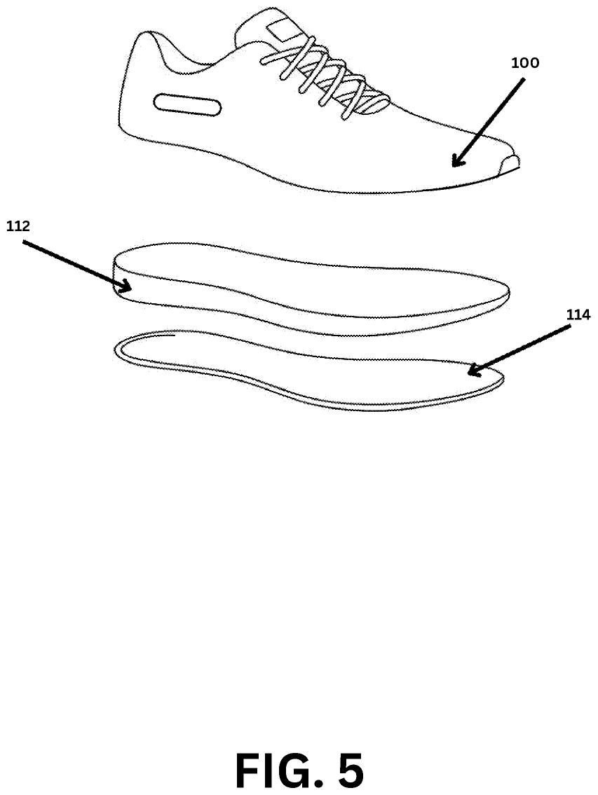

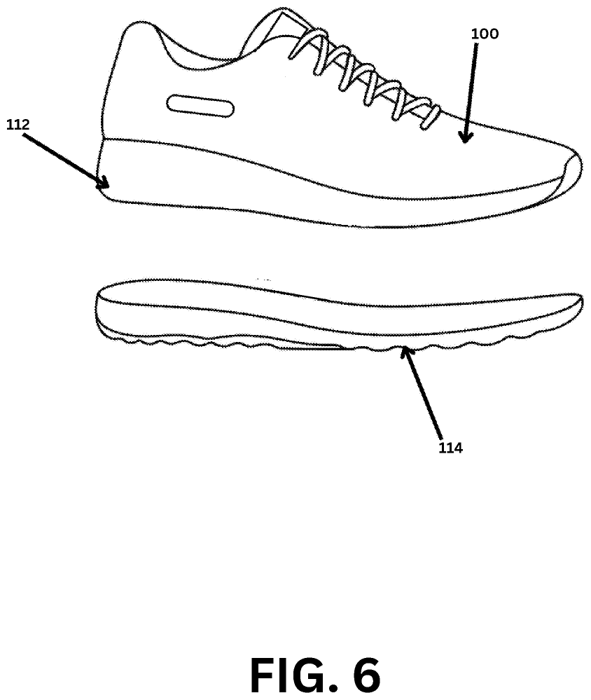

The following description sets forth, for the smart footwear implementation, the system-level data-flow and connectivity architecture described above, with the footwear-specific sensing and actuating elements of FIGS. 1 through 6 as one example.

In operation of the modular wearable system, sensor data flows from sensing elements housed within the Mótus™ pod 130, and from any optional carrier-side sensors electrically coupled to the pod through the standardized interface, to the processor 164. The processor may receive inertial measurement signals, carrier-identification signals, contact-detection signals, pod orientation signals, and other sensor inputs useful for movement tracking, carrier detection, left/right role assignment, and Reflexion OS coordination.

The processor 164 executes firmware stored within the memory module 166 to interpret received sensor data. By way of non-limiting example, the processor 164 may compute step count, gait cadence, stride length, stride symmetry, jump count, jump height, foot pronation, supination, balance asymmetry, movement events, carrier state, and device orientation from inertial signals generated by the Mótus™ pod 130 and from any optional carrier-side sensor signals available through the standardized interface.

In response to the foregoing computations, and to control signals received from Reflexion OS through the wireless communication module 168, the processor 164 may issue output commands to one or more output components of the Mótus™ pod or carrier. By way of non-limiting example, the processor may command a display screen 102 where present, a light indicator strip 108 where present, one or more haptic feedback motors 176, audio components, status indicators, or software outputs presented through a companion device 200 or cloud-hosted service 202.

Bidirectional wireless communication is maintained between the Mótus™ pod 130 and a companion device 200 through the wireless communication module 168 over any of the wireless protocols described herein. The companion device 200 may comprise one or more of a mobile telephone, a tablet computing device, smart wristwear, smart eyewear, augmented or virtual reality headwear, or another computing device configured to execute Reflexion OS. Sensor-derived data, computed movement metrics, and event logs may be transmitted from the Mótus™ pod 130 to the companion device 200 for presentation, storage, analysis, or synchronization with cloud-hosted services 202.

The companion device 200 may communicate with one or more cloud-hosted services 202 associated with Reflexion OS. Communication between the companion device 200 and the cloud-hosted services 202 may proceed over cellular data networks, Wi-Fi networks, or other internet-protocol networks. Where multiple Mótus™ pods are operated as a pair, communication between the pods may proceed directly by peer-to-peer wireless protocol, through the companion device 200 acting as a relay, through the cloud-hosted service 202, or by a combination of the foregoing.

### Reflexion OS Behavior in the Smart Footwear Embodiment

The detachable Mótus™ pod 130, when seated within the module cavity 132 of the smart footwear body 100 or detachable tongue assembly 140, is configured to operate wirelessly and to connect, by way of the wireless communication module 168 housed within the Mótus™ pod 130, to Reflexion OS executing on a companion device 200, on a cloud-hosted service 202, on the Mótus™ pod 130 itself, or distributed among the foregoing. The footwear carrier thereby participates in the wearable ecosystem through the Mótus™ pod 130, rather than by requiring a separate full computing system permanently embedded in the shoe.

User experience may be further enhanced through mobile application pairing, display-equipped pod customization, status-light customization, haptic feedback, audio synchronization with other wearable devices, and software services provided through Reflexion OS.

Communication between the smart footwear body 100 and Reflexion OS may be conducted over any of the Wireless Protocols. Encrypted authentication mechanisms may be employed to ensure that only authorized companion devices may exchange data with the smart footwear body 100, and biometric authentication based upon gait signatures detected by the motion tracking sensor array 120 may be employed as an additional or alternative authentication factor.

### Optional Visual and Status Customization

The modular wearable system may support visual customization through display-equipped Mótus™ pods, pod status indicators, carrier light indicators, decorative cavity inserts, or passive exterior design elements. Such customization features are optional and are not required for operation of the removable-pod and standardized-cavity architecture.

Optional visual and status customization may be initiated through Reflexion OS or through local inputs available on the Mótus™ pod or compatible carrier. Such customization may include display content where a display is present, status-light behavior, haptic patterns, audio cues, or companion-device software presentation.

### Representative Modes of Operation

The modular wearable system disclosed herein may operate in any of a plurality of modes, the selection among which may be controlled by Reflexion OS, by user input, or automatically by context detection. Representative modes of operation include, without limitation: a fitness mode; a movement or gait-analysis mode; a training mode; a rehabilitation-support mode; a game-input mode; a carrier-identification mode; a presentation or status-display mode; a charging mode; and a low-power storage mode. The representative modes may apply differently depending on whether the Mótus™ pod is installed in a footwear carrier, wrist carrier, clip carrier, glove carrier, tongue carrier, or other compatible carrier.

The foregoing modes are illustrative and are not exhaustive. Additional modes may be defined and deployed through software updates delivered by Reflexion OS without modification to the physical structure of the smart footwear body 100.

### Detachable Electronics Module in the Smart Footwear Body

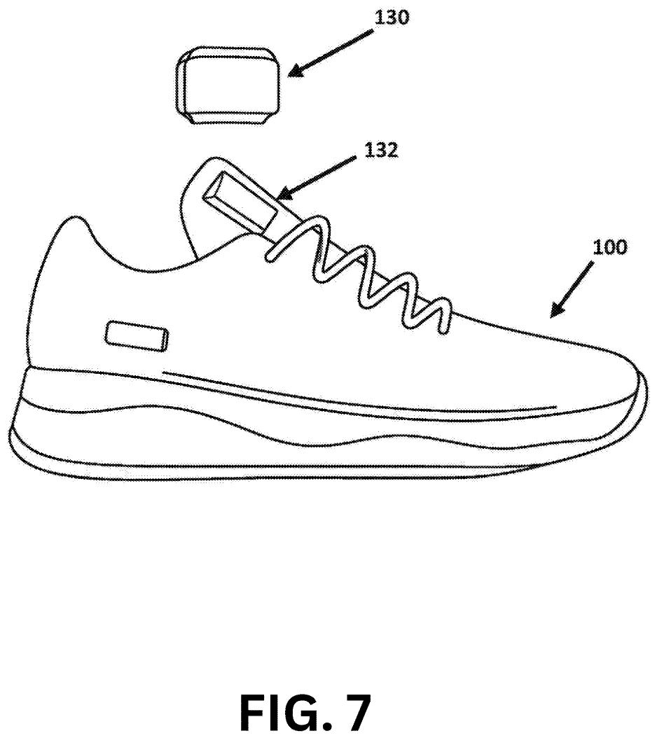

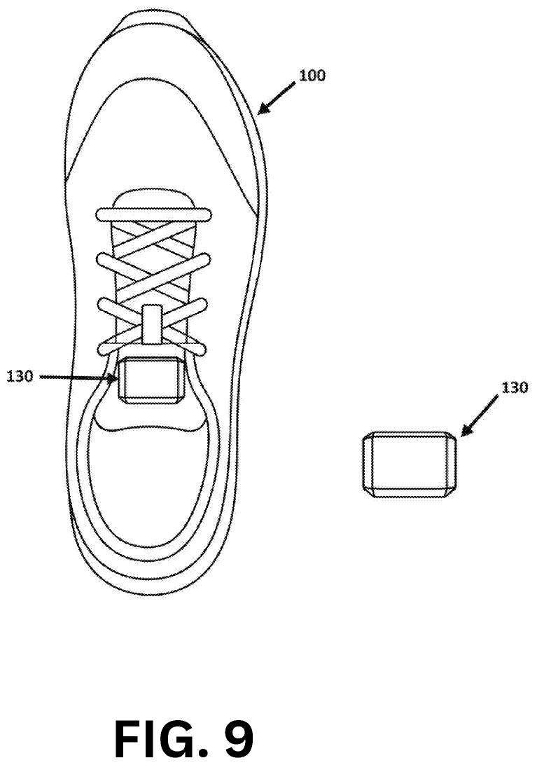

Referring now to FIG. 7, in one or more further embodiments of the present invention, the smart footwear body 100 includes a detachable electronics module 130 sized and shaped to be removably received within a corresponding module cavity 132 formed within the footwear body 100. The module cavity 132 is preferably formed in the tongue region of the footwear body 100 in alignment with the location occupied in other embodiments by the display screen 102, although alternative locations including, without limitation, the medial side panel, the lateral side panel, the heel counter, and the sole region are also within the scope of the invention. The detachable electronics module 130 is the Mótus™ pod described above, housing the Pod Core Components and, optionally, the display screen 102 and the other components described in that section, such that the principal electronic functionality of the smart footwear system may be removed from the footwear body 100 as a single unit. FIG. 9 is a top plan view of the footwear carrier with the Mótus™ pod 130 removed from the module cavity 132 thereof.

The detachable electronics module 130 has the housing materials, geometries, sealing, and flush-fit characteristics described above, shaped to conform to the corresponding module cavity 132 formed in the smart footwear body 100.

### Cavity Alignment Features and Attachment Mechanism

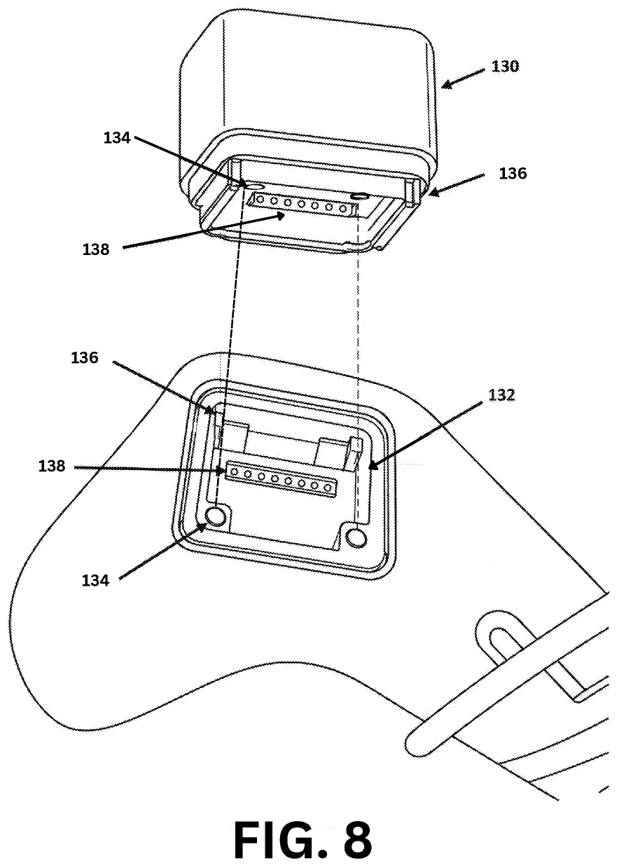

Referring further to FIG. 7 and to FIG. 8, the standardized pod cavity and socket interface is illustrated, showing the Mótus™ pod 130, the module cavity 132, one or more cavity alignment or keying features 134, a retention mechanism 136, and a plurality of electrical contacts 138. The module cavity 132 includes one or more cavity alignment features 134, which may comprise any of the cavity alignment features described above, such as chamfered lead-in surfaces and keyed guide rails. The cavity alignment features 134 cooperate with corresponding features on the detachable electronics module 130 to guide the wearer in installing the detachable electronics module 130 in a unique and correct orientation, to constrain motion of the detachable electronics module 130 within the module cavity 132 once seated, and to align electrical contacts as further described below.

Referring to FIG. 8, the detachable Mótus™ pod 130 is secured within the module cavity 132 by an attachment mechanism 136. In a presently preferred embodiment, the attachment mechanism 136 comprises opposed sliding rails or keyed guide surfaces that guide the Mótus™ pod into a seated position, a resilient snap-fit latch or user-releasable mechanical latch that locks the pod in the seated position, and a compliant gasket or lip seal disposed around the cavity perimeter to resist sweat, moisture, and particulates. Optional magnetic elements may assist alignment, but mechanical retention, electrical contact alignment, and sealing may be provided by any suitable combination of rails, latches, magnets, clips, gaskets, friction fit, or hybrid mechanisms.

### Electrical Interconnect and Hot-Swappable Operation

Referring further to FIG. 8, the module cavity 132 includes a plurality of electrical contacts 138 positioned to align with corresponding contacts on the Mótus™ pod 130 when the Mótus™ pod 130 is seated within the module cavity 132. The electrical contacts 138 may provide electrical power, ground, carrier identification, charging, and data communication between the Mótus™ pod 130 and optional carrier-side components, including without limitation a power light indicator strip 108, a carrier-side charging interface, a status indicator, a haptic output device, a carrier identification circuit, or a supplemental sensor.

The modular wearable system supports the hot-swappable operation described above: the processor 164 detects insertion or removal of the Mótus™ pod 130 by monitoring one or more contact, identification, magnetic, wireless, or inertial signals and transitions the pod and any carrier-side components into appropriate operational states so that the pod may be inserted into or removed from the module cavity 132 without damage to the pod, carrier, or associated electronic components.

### Detachable Tongue Assembly

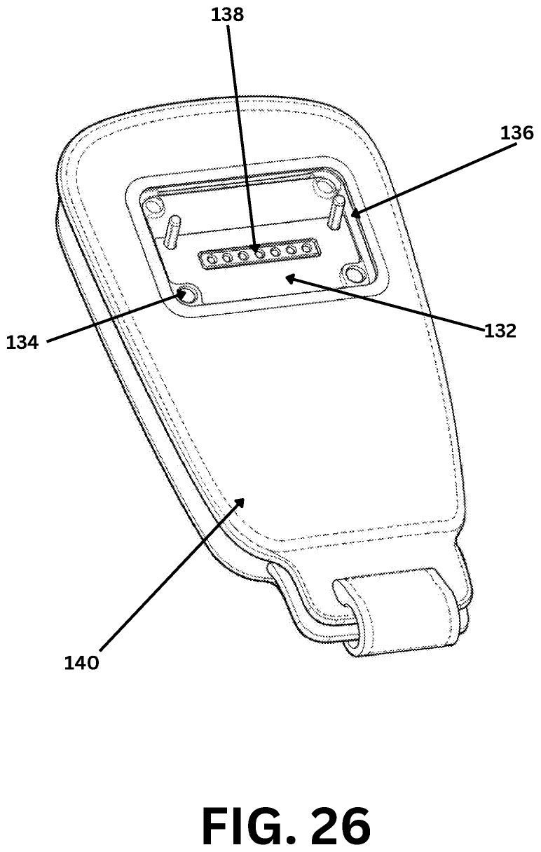

In one or more further embodiments, the entire tongue region of the smart footwear body is provided as a detachable tongue assembly 140, as shown in FIG. 26. The detachable tongue assembly may function as a tongue-mounted carrier for the Mótus™ pod and may include a module cavity 132, alignment features 134, an attachment mechanism 136, and electrical contacts 138 configured to receive and retain the Mótus™ pod. The detachable tongue assembly may be removably coupled to the footwear body by one or more snap fasteners, rails, hook-and-loop regions, magnetic coupling regions, zipper tracks, keyed slides, or mechanical latches so that the tongue assembly can be removed from the footwear body independently of the pod.

In a presently preferred detachable-tongue embodiment, the detachable tongue assembly is treated as a deliberate user-swappable or service-replaceable carrier subassembly. The detachable tongue assembly may be partially detached from the upper along one or more lateral, medial, or proximal fastener paths while remaining temporarily supported by a hinge, tether, flexible circuit, or service stop, thereby allowing the cavity interface to be exposed, inspected, cleaned, charged, or replaced.

Provision of a detachable tongue assembly enables the wearer or service provider to remove or replace the tongue-mounted carrier independently of the remainder of the footwear body. By way of non-limiting example, this permits cleaning or replacement of the footwear body without exposing the Mótus™ pod or tongue carrier electronics to moisture; swapping between detachable tongue assemblies of different styles, cavity tiers, or battery capacities; and using the detachable tongue assembly as a dedicated charging carrier for the Mótus™ pod.

In one or more further embodiments, the detachable tongue assembly 140 itself comprises a battery-integrated or charging-capable tongue carrier. The detachable tongue assembly 140 may include a rechargeable energy storage device 162, charge-management circuitry, an inductive charging coil 178, contact pads, pogo pins, or combinations thereof, electrically coupled to the module cavity 132 so that the detachable tongue assembly can charge a Mótus™ pod docked within the tongue cavity, whereby the battery-integrated tongue assembly operates as a removable charging carrier for the Mótus™ pod without requiring the entire footwear body to contain the primary electronics of the system. When the Mótus™ pod is seated within the module cavity 132 of the detachable tongue assembly 140, the alignment features 134 position the pod, the attachment mechanism 136 retains the pod, and the electrical contacts 138 electrically couple the pod to the charging structure. The detachable tongue assembly 140 may additionally charge the Mótus™ pod through a charging connector or cable, and may remain coupled to the smart footwear body 100 while receiving power from an external charger, dock, or cable.

The detachable tongue assembly may be electrically recharged when removed from the smart footwear body and placed upon a corresponding charging dock or wireless charging surface, and may charge the Mótus™ pod when the pod is seated in the tongue assembly. In other embodiments, the detachable tongue assembly is passive and provides mechanical retention and protection only.

The detachable tongue assembly is in one or more embodiments provided as one of an interchangeable plurality of detachable tongue assemblies configured to be installed alternately within a corresponding plurality of smart footwear bodies of differing footwear style or fashion treatment, such that a single detachable tongue assembly may be transferred among compatible smart footwear bodies in a user's collection.

### Multi-Mode Dual-Use Operation as a Wearable Accessory

In one or more further embodiments, the Mótus™ pod 130 is selectively convertible between a footwear-mounted mode of operation and a wearable-accessory mode of operation. In the footwear-mounted mode of operation, the Mótus™ pod 130 is seated within the module cavity 132 of the smart footwear body 100 or detachable tongue assembly 140. In the wearable-accessory mode of operation, the Mótus™ pod 130 is removed from the footwear module cavity 132 and is removably coupled to a clip accessory 148, wristband carrier 300, wristwatch carrier 300, glove carrier 330, standalone carrier, or other compatible carrier.

The Mótus™ pod 130 is configured to detect the carrier to which it is presently coupled by means of one or more sensing techniques, including identification through dedicated identification contacts among the electrical contacts 138, near-field communication or radio-frequency identification interrogation of an identifier element disposed within the carrier, mechanical keying, magnetic sensing, or detection of orientation and motion patterns characteristic of a foot, wrist, clip, glove, tongue, or other placement. Upon detecting the present carrier, the Mótus™ pod 130 automatically adjusts operating parameters in accordance with the detected coupling.

### Size-Tiered Cavity Configurations

In one or more further embodiments, the module cavity 132 is formed in any one of a plurality of standardized cavity dimensions, the plurality of standardized cavity dimensions accommodating different sizes of detachable electronics module 130 to support a tiered offering of hardware configurations. By way of non-limiting example, a smaller standardized cavity dimension may correspond to an entry-level or compact hardware configuration suitable for casual use, while one or more larger standardized cavity dimensions may correspond to advanced or premium hardware configurations including additional sensors, larger displays, or higher-capacity rechargeable energy storage devices. The interface dimensions of the cavity alignment features 134, the attachment mechanism 136, and the electrical contacts 138 are preferably standardized within each tier such that any detachable electronics module 130 conforming to a given tier may be received within any module cavity 132 of that same tier.

### Non-Functional Decorative Inserts

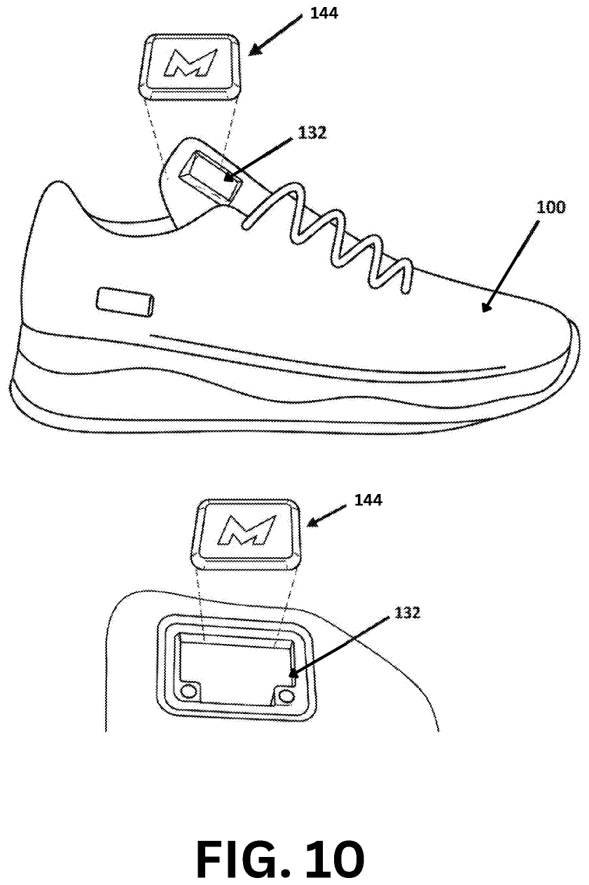

Referring to FIG. 10, in one or more further embodiments, the smart footwear system further comprises a non-functional decorative insert 144 sized and shaped to occupy the module cavity 132 when no detachable electronics module 130 is installed therein. The non-functional decorative insert 144 may comprise, without limitation, one or more of a graphic logo, a holographic surface, a textile patch, a metallic emblem, an embroidered panel, a brand-coordinated color tile, a translucent panel, and a backlit panel (collectively, the “Decorative Insert Materials”). The non-functional decorative insert 144 is preferably retained within the module cavity 132 by means of the same or compatible attachment mechanism 136 used to retain the detachable electronics module 130, such that the wearer may interchange between functional and decorative occupants of the module cavity 132 without modification to the smart footwear body 100. Provision of the non-functional decorative insert 144 ensures a flush, fashion-coordinated appearance of the smart footwear body 100 when the wearer elects not to install a detachable electronics module 130 therein.

### Dual-Screen Operation Across a Pair of Footwear Bodies

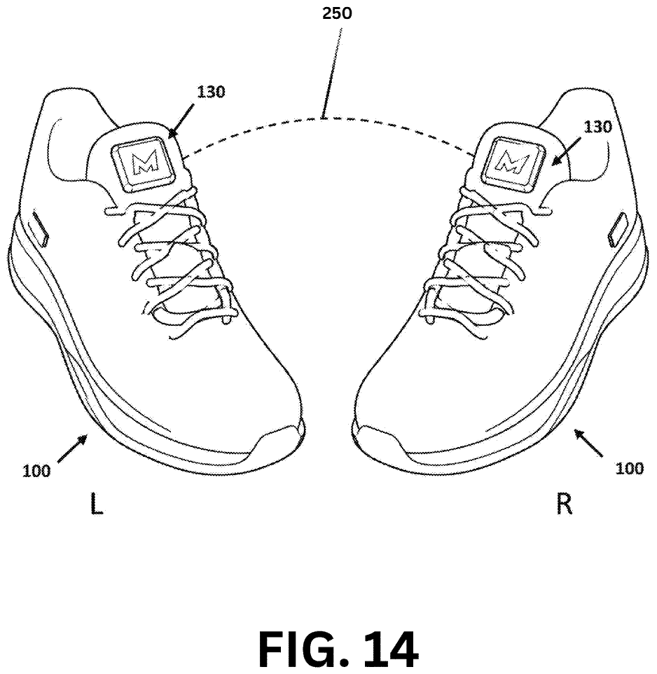

Referring to FIG. 14, in one or more further embodiments of the present invention, the smart footwear system is provided as a pair comprising a left footwear body and a right footwear body. Each of the left footwear body and the right footwear body includes a respective module cavity 132 configured to receive a respective detachable electronics module 130. Upon installation of detachable electronics modules 130 in both the left footwear body and the right footwear body, the two detachable electronics modules 130 may operate either in an independent mode, in which content presented on each detachable electronics module 130 is unrelated to content presented on the other, or in a synchronized mode, in which content presented on each detachable electronics module 130 is coordinated with content presented on the other through wireless communication conducted directly between the two detachable electronics modules 130 or by way of Reflexion OS executing on a paired companion device.

By way of non-limiting example, the synchronized mode of operation may include presentation of a single composite graphic spanning the two displays when the wearer's feet are placed adjacent one another; coordinated animations responsive to gait phase that emphasize the symmetry or asymmetry of the wearer's stride; turn-by-turn navigation prompts in which directional cues are presented on the appropriate left or right display to indicate the corresponding direction of travel; and team or game mode features in which the two displays cooperate to convey shared status information.

### Coordinated Motion Event Disambiguation in Paired-Footwear Operation

Referring to FIG. 14, in one or more further embodiments of the present invention, a pair of Mótus™ pods, installed respectively in the left footwear body 100 and the right footwear body 100 of the smart footwear system and configured to wirelessly synchronize over a wireless synchronization path 250 for paired-pod motion classification, cooperate under Reflexion OS to disambiguate among motion events of the user that would be ambiguous or indistinguishable on the basis of the motion data of either pod considered alone. Each Mótus™ pod of the pair samples acceleration, angular rate, and orientation data from its motion tracking sensor array 120, and pressure data from the heel sensor pad 116 and the front sensor pad 118 of the corresponding smart footwear body 100, and transmits time-stamped foot-strike events, foot-lift events, peak-impact magnitude values, and orientation samples to the other pod of the pair, to Reflexion OS executing on a paired companion device 200, or both.

Reflexion OS, the Mótus™ pods of the pair, or both, are configured to classify the user's motion among a plurality of motion-event classes (collectively, the “Motion-Event Classes”), including, without limitation, a step, a walking or running gait, a stomp, a hop, a bilateral squat, a unilateral lunge, a kick, and a jumping jack, on the basis of the relative timing, magnitude, and orientation of foot-strike and foot-lift events at the two pods. The numeric thresholds used in any such motion-event classification, including, without limitation, the stomp-window time interval, the stomp-magnitude threshold, the hop-magnitude threshold, the squat-window time interval, the squat-acceleration thresholds, the stride-displacement thresholds, and the angular-rate thresholds, are tunable parameters that may be adjusted by Reflexion OS, by the user, or by an authorized application, and the present disclosure does not commit to any particular numeric value for any such threshold. Motion-event classification may further be based on additional signals including, without limitation, relative cadence, pressure distribution across the heel sensor pad 116 and the front sensor pad 118, bilateral comparison between the left Mótus™ pod and the right Mótus™ pod, ground-contact time, stance and swing phase identification, and stride symmetry, and may be computed on each Mótus™ pod, on a paired companion device 200, on a cloud-hosted service 202, or distributed among any combination of the foregoing. By way of non-limiting example, a stomp event is recognized when foot-strike events are detected at both the left Mótus™ pod and the right Mótus™ pod within a stomp-window time interval, the foot-strike events each exceeding a stomp-magnitude threshold, and the orientation of both pods being consistent with both feet bearing on the ground at substantially the same time, whereas a hop event is recognized when a foot-strike event is detected at only one of the two Mótus™ pods, the foot-strike event exceeding a hop-magnitude threshold, the other Mótus™ pod reporting an absence of pressure on the corresponding sensor pads and an orientation consistent with elevation of that foot above the ground, and a subsequent foot-strike event being detected at the same Mótus™ pod consistent with landing on the same foot from which the user took off.

A walking or running step is similarly recognized as a sequence of alternating foot-strike events at the left and right Mótus™ pods, with successive foot-strike events at the same pod separated by a cadence interval characteristic of bipedal locomotion. A squat or other sustained bilateral ground contact is recognized when both Mótus™ pods report sustained pressure on the heel sensor pad 116 and the front sensor pad 118 together with a downward vertical-acceleration profile followed by an upward vertical-acceleration profile measured at both pods within a squat-window time interval, whereas a unilateral lunge is recognized when only one Mótus™ pod reports the squat-characteristic acceleration profile while the other Mótus™ pod reports a forward or backward stride displacement. A kick is recognized when one Mótus™ pod reports an absence of pressure on the corresponding sensor pads together with a high-amplitude angular-rate excursion characteristic of swing-phase kicking motion, while the other Mótus™ pod reports sustained pressure on the corresponding sensor pads consistent with the user's weight bearing on the stationary supporting foot.

Persons skilled in the art will appreciate that each of the foregoing carriers operates in the same manner as the smart footwear and wrist-mounted implementations described herein with respect to pod installation, carrier detection, data flow, connectivity, Device Role assignment, and Reflexion OS coordination, the Mótus™ pod providing the core computing, sensing, optional display, and wireless functions and the carrier providing form-factor-appropriate mounting, retention, and optional auxiliary support.

### Manufacture, Assembly, and Service

The smart footwear body 100 and compatible carriers described herein may be assembled by means conventional in the footwear, wearable, and consumer electronics arts. By way of non-limiting example, electronic components may be encapsulated in conformal coatings prior to integration to provide resistance to moisture and mechanical shock. In one or more embodiments, the detachable Mótus™ pod 130, passive or decorative cavity insert 144, wristband or wristwatch carrier 300, clip carrier 148, rehabilitation, ankle, brace, sleeve, orthotic, or medical-adjacent carrier 310, glove or hand-worn carrier 330, detachable tongue assembly 140, and charging dock 180 are modular components configured to be removed, replaced, serviced, or upgraded separately from the main footwear body or other carrier.

### Wrist-Mounted Implementation of the Modular Wearable System

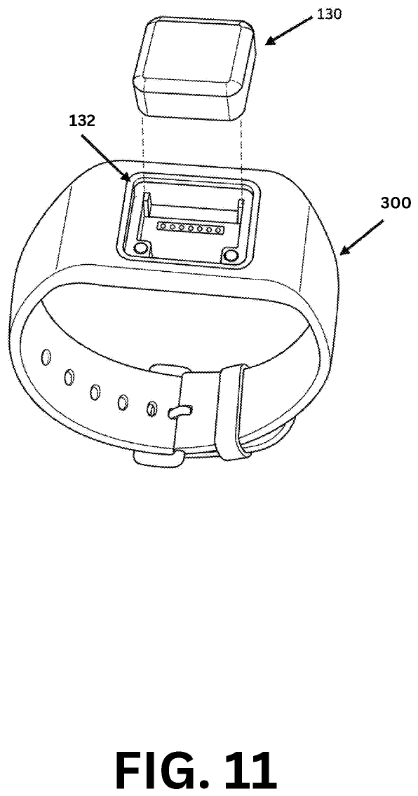

Referring to FIG. 11, a wristband or wristwatch carrier 300 is illustrated, the wristband or wristwatch carrier 300 being configured to removably receive a Mótus™ pod 130 through a standardized cavity and socket interface 132. The following description sets forth a wrist-mounted implementation of the modular wearable system disclosed herein. In the wrist-mounted implementation, a Mótus™ pod is received within a wristband carrier or a wristwatch carrier, and is worn upon the wrist of the user. The wrist-mounted implementation comprises one of: a wristband carrier configured as a band of textile, polymer, leather, metal, or combinations thereof, configured to encircle the wrist of the user and to retain a Mótus™ pod in a module cavity 132 formed within the band; and a wristwatch carrier configured as a watch case retained upon a wristwatch strap, the watch case including a module cavity 132 formed within the watch case and configured to removably receive the Mótus™ pod in the location otherwise occupied by a conventional watch movement, such that the wristwatch carrier presents the appearance of a conventional wristwatch while housing the Mótus™ pod and providing electrical interface to the Mótus™ pod by way of electrical contacts 138 analogous in form and function to those of the smart footwear body 100.

### Wristband and Wristwatch Carrier Construction

The wristband or wristwatch carrier of the wrist-mounted implementation includes an attachment mechanism 136 selected from any one or more of the attachment mechanisms 136 described elsewhere herein, including, without limitation, a mechanical latch, a snap-fit feature, a magnetic coupling, a twist-lock coupling, a hook-and-loop fastener, and a sliding rail. The wristband or wristwatch carrier may be passive, in which case the Mótus™ pod provides the primary sensors, processor, wireless communication module, and battery, or may be active, in which case the carrier may include electrical contacts, a supplemental power source, or one or more carrier-side sensors electrically coupled to the Mótus™ pod through the standardized interface.

### Mótus Pod Operation in Wrist Mode

Upon installation of a Mótus™ pod within the wristband or wristwatch carrier, the Mótus™ pod, by way of any one or more of the carrier-detection mechanisms described elsewhere herein, detects that it is presently coupled to a wristband or wristwatch carrier and configures its operating parameters, user-interface presentation, sensor duty cycles, and assigned device role accordingly. By way of non-limiting example, the Mótus™ pod, when so coupled, may present on the display screen 102, where present, current time, notifications, fitness metrics derived from the motion tracking sensor array 120, battery status, carrier status, or other software outputs, and may reorient display content such that the display screen 102 reads correctly to the user when the user's wrist is rotated to view the carrier.

### Interoperability With Footwear-Installed Pods and Other Carriers

In one or more further embodiments, a wrist-mounted Mótus™ pod is configured to communicate wirelessly with one or more additional Mótus™ pods worn by the same user, including, without limitation, one or more Mótus™ pods installed within a smart footwear body 100, an ankle band carrier, a clip-on carrier, a standalone carrier, or a rehabilitative or medical wearable carrier of the user. Reflexion OS coordinates the operation of the wrist-mounted Mótus™ pod and the additional Mótus™ pods according to the carrier types detected and the device roles dynamically assigned to each Mótus™ pod.

By way of non-limiting example, when a wrist-mounted Mótus™ pod is worn together with a pair of foot-mounted Mótus™ pods installed in respective smart footwear bodies 100, Reflexion OS may assign the wrist-mounted Mótus™ pod as the primary display and notification source for the user while assigning the foot-mounted Mótus™ pods as primary sensor sources for gait, stride, and motion event classification, including the Motion-Event Classes described elsewhere herein. Sensor data derived at the foot-mounted Mótus™ pods is wirelessly transmitted to the wrist-mounted Mótus™ pod for presentation to the user on the display screen 102 of the wrist-mounted Mótus™ pod, and notifications received at the wrist-mounted Mótus™ pod from the paired companion device 200 may be selectively forwarded to the foot-mounted Mótus™ pods for tactile reproduction by the haptic feedback motors 176 of the smart footwear body 100.

### Watch-Only Mode and Standalone Operation

In one or more further embodiments, the wrist-mounted Mótus™ pod is configured to support a watch-only mode in which the Mótus™ pod operates as a wrist-mounted accessory using the processor, wireless communication module, sensors, display if present, and rechargeable energy storage device housed within the Mótus™ pod. In the watch-only mode, the wrist-mounted carrier need not contain a separate power source unless the carrier is expressly implemented as an active carrier with supplemental charging or sensing functions.

### Ankle, Clip, Glove, Standalone, and Medical-Adjacent Carrier Implementations

The following description sets forth additional carrier implementations of the modular wearable system. In each such implementation, a Mótus™ pod is removably received within a module cavity 132 of the carrier that conforms to the standardized cavity and socket interface, including the cavity alignment features 134, the module attachment mechanism 136, and, for an electrically active carrier, the electrical contacts 138, and the pod, upon detecting the carrier type by way of the Carrier-Detection Mechanisms, configures its operating parameters, user-interface presentation, sensor duty cycles, and assigned Device Role in accordance with the detected carrier. Each such carrier operates using the Pod Core Components and communicates, over any of the Wireless Protocols, with one or more other Mótus™ pods, a companion device 200, and one or more cloud-hosted services 202, in the manner described above.

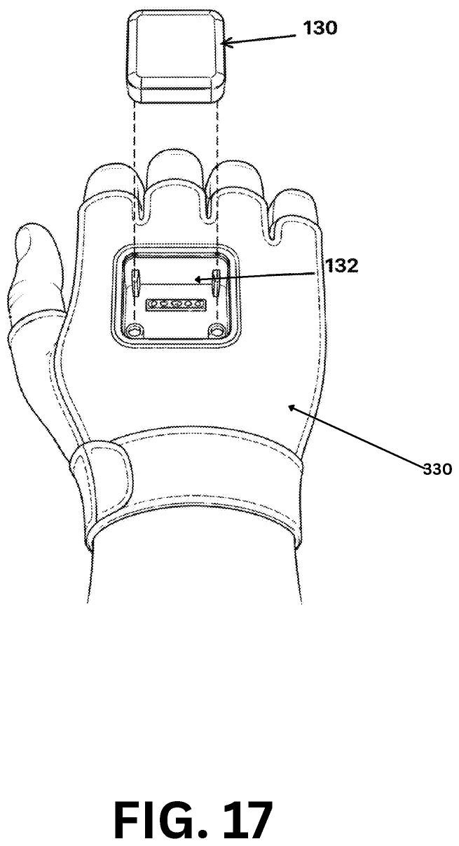

In an ankle band carrier, the pod is received within a module cavity 132 formed in a band worn about the ankle and is configured for gait, cadence, step, impact, and asymmetry sensing, and may serve as a primary or secondary sensor source complementing or substituting for a foot-mounted pod. In a clip carrier 148, as illustrated in FIG. 13, the pod is received within a clip body releasably attached to clothing, a belt, a bag strap, a backpack, or another personal item, and is configured for general activity and motion tracking and for notification relay; the clip carrier may be electrically active or a passive carrier in which the pod is mechanically retained but operates wirelessly on onboard power. In a glove or hand-worn carrier 330, as illustrated in FIG. 17, the pod is carried on the back of the hand and is configured for hand and arm motion, gesture, and game-input sensing, with a display screen 102, where present, oriented to face the back of the hand. In a standalone carrier, the pod is received within a self-supporting cradle, case, or fob carried independently of any worn article and operates as a complete wearable computer on the basis of the Pod Core Components and onboard power. In a rehabilitative or medical-adjacent carrier 310, such as illustrated in FIG. 12, the pod is received within a brace, sleeve, orthosis, prosthesis, post-operative compression garment, or other medical-adjacent wearable structure and is configured for monitoring, adherence, gait or asymmetry tracking, balance screening, return-to-walk progression, and clinician workflow support, and may be provided as a Medical Tier Class pod sealed against ingress.

Persons skilled in the art will appreciate that each of the foregoing carriers operates in the same manner as the smart footwear and wrist-mounted implementations described herein with respect to pod installation, carrier detection, data flow, connectivity, Device Role assignment, and Reflexion OS coordination, the Mótus™ pod providing the core computing, sensing, optional display, and wireless functions and the carrier providing form-factor-appropriate mounting, retention, and optional auxiliary support.

### Additional Preferred Embodiments

In one or more further embodiments of the present invention, the modular wearable system, the smart footwear system, and the wrist-mounted system disclosed herein contemplate and include any one or more of the following additional embodiments. A decorative cavity cover, separate from or incorporating the non-functional decorative insert 144, may be removably installed within the module cavity 132 to present a customized exterior appearance, the decorative cavity cover comprising one or more of the Decorative Insert Materials. The system may further include a logo or display upload system, by way of which the user, through Reflexion OS or through a local control interface, may upload to the display screen 102, the power light indicator strip 108, or other electronic surface, custom graphical content including, without limitation, logos, images, animations, profile photographs, and team or brand markings, the uploaded content being stored within the memory module 166 of the Mótus™ pod and being selectable for presentation by the user.

The modular wearable system may further be configured to perform inertial measurement unit orientation locking, in which the motion tracking sensor array 120 of the Mótus™ pod establishes a reference orientation upon installation within a given carrier and thereafter reports orientation relative to that reference, such that user-interface elements presented on the display screen 102 maintain consistent visual orientation to the user irrespective of physical mounting orientation. The modular wearable system may further support a shoe-only mode, in which the Mótus™ pod operates exclusively within a smart footwear body 100, with sensor sampling, display content, and battery management configured for sustained foot-borne use, complementing the watch-only mode described elsewhere herein.

The modular wearable system is in one or more embodiments configured to support dual-pod synchronization, in which two Mótus™ pods, whether installed in left-foot and right-foot smart footwear bodies 100, in left and right wristbands, or in any combination of compatible carriers, communicate wirelessly with one another to coordinate display content, sensor sampling, motion event recognition, and game-input reporting. Left and right role assignment may be performed automatically by Reflexion OS based upon orientation, gait phase, or user designation, and may be transferred between Mótus™ pods in real time as the user changes carriers. The modular wearable system may further be configured to operate as a motion-controlled gaming input device, in which one or more Mótus™ pods report motion events including, without limitation, steps, jumps, stomps, kicks, gestures, and pose changes to a paired companion device 200, a paired game console, a paired augmented or virtual reality headset, or a cloud-hosted gaming service 202, the reported motion events constituting game inputs to a game application executing thereon.

### Alternative Embodiments and Scope

Although the present invention has been described above with reference to one or more presently preferred embodiments, the foregoing description is not intended to limit the invention to those embodiments. Numerous modifications and variations will be apparent to those skilled in the art without departing from the spirit and scope of the invention. By way of non-limiting example, the Mótus™ pod, module cavity, detachable tongue assembly, and standardized carrier interface disclosed herein may be implemented in alternative footwear forms, wrist carriers, clip carriers, glove carriers, ankle carriers, standalone carriers, or other wearable and portable carriers while preserving the core removable-pod architecture.

All such modifications and variations are intended to fall within the scope of the appended claims. The terms and expressions employed in the foregoing specification are used as terms of description and not of limitation, and there is no intention, in the use of such terms and expressions, of excluding equivalents of the features shown and described or portions thereof. The scope of the invention is defined and limited only by the claims that follow.

What is claimed is:

1. A modular wearable system, comprising:
a detachable electronics module configured to be removably received within any one of a plurality of compatible cavities, the detachable electronics module housing within a sealed enclosure each of a processor, a memory module, a wireless communication module, an inertial measurement unit, and a rechargeable energy storage device, and further housing one or more of an electronic display, an inductive charging coil, a microphone, and a haptic feedback motor;
a plurality of carriers each comprising a respective cavity sized and shaped to removably receive the detachable electronics module, the plurality of carriers comprising at least two carriers selected from the group consisting of a footwear carrier, a detachable tongue carrier, a wristband carrier, a wristwatch carrier, an ankle band carrier, a clip-on carrier, a glove or hand-worn carrier, a standalone carrier, and a medical wearable carrier, and the respective cavity of each said carrier comprising one or more alignment features and an attachment mechanism configured to mechanically retain the detachable electronics module within the cavity, the respective cavity of at least one said carrier further comprising a plurality of electrical contacts configured to align with corresponding contacts on the detachable electronics module when the detachable electronics module is seated within the cavity to provide electrical power and data communication therebetween; and
a wearable operating system executing on one or more of the detachable electronics module and a companion device wirelessly paired with the detachable electronics module, the wearable operating system being configured to automatically detect, upon coupling of the detachable electronics module to any one of said carriers, the type of carrier to which the detachable electronics module is presently coupled, and in response thereto to dynamically configure operation of the detachable electronics module, said dynamic configuration including modifying one or more of user-interface presentation through one or more output modalities of the detachable electronics module or of the carrier to which the detachable electronics module is presently coupled, sensor duty cycle of the inertial measurement unit, communication behavior of the wireless communication module, and a device role assigned to the detachable electronics module, in accordance with the detected type of carrier;
wherein the respective cavities of the plurality of carriers share a standardized mechanical alignment geometry and a standardized electrical contact pattern such that the detachable electronics module is operable, without modification, in any cavity of the plurality of carriers.

2. The modular wearable system of claim 1, wherein the respective cavity of each said carrier comprises a retention system selected from one or more of rails, latches, magnets, clips, gaskets, friction fit, and any combination thereof.

3. The modular wearable system of claim 1, wherein the respective cavity of each said carrier is configured as a sealed cavity providing water resistance and sweat resistance to electronic components retained therein, the sealed cavity comprising one or more of a gasket, a compliant lip, a flexible cover, and a conformal coating.

4. The modular wearable system of claim 1, wherein the respective cavity of each said carrier is provided in any one of a plurality of cavity tier classes including at least a Lite tier class, a Pro tier class, a Medical tier class, and a Performance tier class, wherein the detachable electronics module is provided in one of a corresponding plurality of module tier classes mechanically and electrically compatible with the cavity tier classes, and wherein the modular wearable system further comprises a decorative cavity insert sized and shaped to occupy any cavity of the plurality of carriers when the detachable electronics module is not installed therein.

5. The modular wearable system of claim 1, wherein the respective cavity of at least one said carrier is configured to electrically charge the detachable electronics module by way of one or more of spring-loaded pogo-pin contacts, contact-pad charging, wireless inductive charging in accordance with a wireless-power standard, and dock-assisted charging in which the detachable electronics module or said respective carrier is received within a docking station.

6. The modular wearable system of claim 1, wherein the detachable electronics module is configured to be hot-swappable, such that the detachable electronics module may be inserted into and removed from the respective cavity of any said carrier during operation of the modular wearable system, the modular wearable system is further configured to perform automatic synchronization of stored data between the detachable electronics module and said respective carrier upon insertion or removal of the detachable electronics module from the respective cavity, and the wearable operating system is further configured to perform module authentication of the detachable electronics module through the electrical contacts of the respective cavity, the module authentication being performed by way of one or more of a digital identification pin, a secure element challenge-response exchange, a near-field communication or radio-frequency identification identifier, and a biometric gait signature detected by the inertial measurement unit.

7. The modular wearable system of claim 1, comprising a plurality of said detachable electronics modules worn by a common user, the wearable operating system being further configured to detect a left-side or right-side orientation of each said detachable electronics module, to dynamically assign device roles among the plurality of detachable electronics modules, and to synchronize motion telemetry across the plurality of detachable electronics modules, the motion telemetry comprising one or more of step events, jump events, stomp events, kick events, gesture events, and game-input events.

8. The modular wearable system of claim 1, wherein the plurality of carriers comprises a left smart footwear body and a right smart footwear body, each of the left and right smart footwear bodies including a respective said cavity, each said respective cavity having a respective said detachable electronics module installed therein, each said respective detachable electronics module being configured to detect foot-strike and foot-lift events of the corresponding foot of a user and to wirelessly communicate time-stamped foot-strike and foot-lift events to the other said detachable electronics module, and wherein the wearable operating system is configured to classify motion of the user among a plurality of motion-event classes including at least a stomp event class and a hop event class, the stomp event class being recognized when foot-strike events are detected at both said detachable electronics modules within a stomp-window time interval and the hop event class being recognized when a foot-strike event is detected at only one of the two detachable electronics modules.

9. The modular wearable system of claim 1, wherein the plurality of carriers comprises the footwear carrier embodied as a smart footwear body that comprises a tongue-region module cavity configured to receive the detachable electronics module, a power light indicator strip extending along an exterior surface of the smart footwear body, and a carrier-side charging interface electrically coupled to the tongue-region module cavity.

10. The modular wearable system of claim 9, wherein the smart footwear body further comprises a detachable tongue assembly removably coupled to the smart footwear body, the detachable tongue assembly comprising a module cavity configured to receive the detachable electronics module and a charging structure configured to charge the detachable electronics module while the detachable electronics module is seated within the module cavity of the detachable tongue assembly.

11. The modular wearable system of claim 1, wherein the plurality of carriers comprises a wrist-mounted carrier embodied as one of the wristband carrier and the wristwatch carrier, the wrist-mounted carrier being configured to be worn upon a wrist of a user and to receive the detachable electronics module within a respective cavity conforming to the standardized mechanical alignment geometry and standardized electrical contact pattern.

12. The modular wearable system of claim 1, wherein the detachable electronics module further houses an electronic display, and wherein the dynamic configuration includes modifying user-interface presentation on the electronic display.

13. The modular wearable system of claim 1, wherein the detachable electronics module is configured to operate without an electronic display, the detachable electronics module presenting status, telemetry, and user feedback to a wearer through one or more of a haptic feedback motor of the detachable electronics module, an indicator light of a carrier to which the detachable electronics module is coupled, and a paired companion device wirelessly paired with the detachable electronics module.

14. A method of operating a modular wearable system, the method comprising:
receiving, by a wearable operating system, a carrier identifier from a detachable electronics module presently coupled to one of a plurality of compatible carriers, the carrier identifier indicating the type of carrier to which the detachable electronics module is presently coupled;
assigning, by the wearable operating system, a device role to the detachable electronics module in accordance with the received carrier identifier;
receiving, by the wearable operating system, motion telemetry transmitted by the detachable electronics module, the motion telemetry comprising one or more of step events, jump events, stomp events, kick events, gesture events, and foot-strike events; and
processing, by the wearable operating system, the motion telemetry into coordinated outputs spanning one or more of a display, a light indicator, a haptic actuator, and an audio output of the carrier.

15. The method of claim 14, wherein the detachable electronics module is installed in a smart footwear body of a user, the method further comprising receiving, by the wearable operating system, additional motion telemetry from a second detachable electronics module installed in a second smart footwear body of the user opposite the smart footwear body in which the detachable electronics module is installed, and classifying motion of the user among a plurality of motion-event classes including at least a stomp event class and a hop event class, the stomp event class being recognized when foot-strike events are detected at both detachable electronics modules within a stomp-window time interval and the hop event class being recognized when a foot-strike event is detected at only one of the two detachable electronics modules.

16. The method of claim 14, further comprising performing, by the wearable operating system, module authentication of the detachable electronics module through one or more of a digital identification pin, a secure element challenge-response exchange, a near-field communication or radio-frequency identification identifier, and a biometric gait signature, and selectively granting operative coupling between the detachable electronics module and the carrier in accordance with a result of the module authentication.

17. A non-transitory computer-readable medium storing instructions that, when executed by one or more processors of a wearable operating system, cause the one or more processors to:
receive a carrier identifier from a detachable electronics module presently coupled to one of a plurality of compatible carriers, the carrier identifier indicating the type of carrier to which the detachable electronics module is presently coupled;
assign a device role to the detachable electronics module in accordance with the received carrier identifier;
receive motion telemetry transmitted by the detachable electronics module, the motion telemetry comprising one or more of step events, jump events, stomp events, kick events, gesture events, and foot-strike events; and
process the motion telemetry into coordinated outputs spanning one or more of a display, a light indicator, a haptic actuator, and an audio output of the carrier.

18. The non-transitory computer-readable medium of claim 17, wherein the detachable electronics module is installed in a smart footwear body of a user, and wherein the instructions further cause the one or more processors to receive additional motion telemetry from a second detachable electronics module installed in a second smart footwear body of the user opposite the smart footwear body, and to classify motion of the user among a plurality of motion-event classes including at least a stomp event class and a hop event class on the basis of the relative timing, magnitude, and orientation of foot-strike and foot-lift events at the two detachable electronics modules.

19. The non-transitory computer-readable medium of claim 17, wherein the instructions further cause the one or more processors to perform module authentication of the detachable electronics module through one or more of a digital identification pin, a secure element challenge-response exchange, a near-field communication or radio-frequency identification identifier, and a biometric gait signature, and to selectively grant operative coupling between the detachable electronics module and the carrier in accordance with a result of the module authentication.

20. The non-transitory computer-readable medium of claim 17, wherein the instructions are distributed for execution across one or more of the detachable electronics module, a companion device wirelessly paired with the detachable electronics module, and a cloud-hosted service in communication with the companion device.
